(19) United States
(12) Patent Application Publication
(10) Pub. No.: US 2026/0080810 A1
(43) Pub. Date: Mar. 19, 2026

(54) IMAGE CONVERSION METHOD AND DISPLAY DEVICE

(71) Applicant: Tianma Advanced Display Technology Institute (Xiamen) Co., Ltd., Xiamen (CN)

(72) Inventor: Yingteng ZHAI, Xiamen (CN)

(73) Assignee: Tianma Advanced Display Technology Institute (Xiamen) Co., Ltd., Xiamen (CN)

(21) Appl. No.: 19/396,803

(22) Filed: Nov. 21, 2025

(30) Foreign Application Priority Data
Dec. 30, 2024 (CN) 202411984028.3

(51) Int. Cl. G09G 3/20

(52) U.S. Cl. CPC G09G 3/2003; G09G 2300/0452; G09G 2320/0666; G09G 2360/145

(57) ABSTRACT

Provided are an image conversion method and a display device. The image conversion method includes: acquiring a target color, and determining a target color point of the target color in a chromatic diagram, where the chromatic diagram includes M primary color points, the M primary color points correspond to M primary colors, M is an integer, and M≥4; defining M driving components corresponding to the M primary colors and a relationship equation between a color coordinate of the target color point and a color coordinate of each primary color point; determining value ranges of the driving components according to the relationship equation, setting a first driving component to a maximum value, and/or setting an M-th driving component to a minimum value, and determining values of remaining (M−1) driving components. The M primary colors include a first primary color to an M-th primary color.

### CROSS-REFERENCE TO RELATED APPLICATION(S)

This application claims priority to Chinese Patent Application No. 202411984028.3 filed Dec. 30, 2024, the disclosure of which is incorporated herein by reference in its entirety.

### TECHNICAL FIELD

The present disclosure relates to the field of display technology and, in particular, to an image conversion method and a display device.

### BACKGROUND

With technological advancements, people are demanding ever-higher color performance from displays, expecting them to deliver richer and more saturated colors.

At present, at least one new primary color different from red, green and blue is generally added to the traditional three-primary-color display, which can effectively enhance the color performance of the display. However, for displays with four or more primary colors, if a target color needs to be displayed, there are countless methods to synthesize the target color.

Therefore, how to determine the unique solution to synthesize the color that needs to be displayed has become an urgent technical problem to be solved at present.

### SUMMARY

The present disclosure provides an image conversion method and a display device.

According to an aspect of the present disclosure, an image conversion method is provided. The image conversion method includes the steps described below.

A target color is acquired, and a target color point of the target color in a chromatic diagram is determined, where the chromatic diagram includes M primary color points, the M primary color points correspond to M primary colors, M is an integer, and M≥4.

M driving components (D01, D02, . . . and D0M) corresponding to the M primary colors and a relationship equation between a color coordinate (X0, Y0, Z0) of the target color point and a color coordinate (Xi, Yi, Zi) of each of the M primary color points: (X0, Y0, Z0)=D01*(X1, Y1, Z1)+D02*(X2, Y2, Z2)+ . . . +D0M*(XM, YM, ZM) are defined, where 1≤i≤M, and i is an integer.

A first value range of a first driving component D01 is determined according to the relationship equation, the first driving component D01 is set to a maximum value within the first value range, and values of remaining (M−1) driving components are determined; and/or an M-th value range of an M-th driving component D0M is determined according to the relationship equation, the M-th driving component D0M is set to a minimum value within the M-th value range, and values of remaining (M−1) driving components are determined.

The M primary colors include a first primary color, a second primary color, . . . and an M-th primary color, a wavelength of the first primary color is greater than at least some wavelengths of the second primary color to the M-th primary color, and a wavelength of the M-th primary color is less than at least some wavelengths of the first primary color to an (M−1)-th primary color.

According to another aspect of the present disclosure, another image conversion method is provided. The image conversion method includes the steps described below.

A target color is acquired, and a target color point of the target color in a chromatic diagram is determined, where the chromatic diagram includes M primary color points, the M primary color points correspond to M primary colors, M is an integer, and M≥4; the chromatic diagram further includes E sub-regions delimited by multiple primary color points, E is an integer, and E≥2; among at least part of the E sub-regions, two sub-regions do not overlap with each other.

Primary colors required to form the target color corresponding to the target color point are determined according to a positional relationship between the target color point and each of the E sub-regions, each of the primary colors is denoted as a first-type primary color, and each of the other primary colors is denoted as a second-type primary color.

A driving component corresponding to the first-type primary color is determined according to a color coordinate of the target color point and a color coordinate of a primary color point of the first-type primary color, and a driving component corresponding to the second-type primary color is set to zero.

The M primary colors include a first primary color, a second primary color, . . . and an M-th primary color, a wavelength of the M-th primary color is less than at least some wavelengths of the first primary color to an (M−1)-th primary color, each of the E sub-regions is delimited by at least three primary color points and at most (M−1) primary color points, and at least one of the E sub-regions is delimited by multiple primary color points excluding an M-th primary color point corresponding to the M-th primary color.

According to another aspect of the present disclosure, a display device is provided. The display device includes multiple pixel units, where each of the multiple pixel units includes M types of primary color pixels, M is an integer, and M≥4.

A display mode of the display device includes a first display mode.

In the first display mode and the same pixel unit, N types of primary color pixels are in a bright state, (M−N) types of primary color pixels are in a black state, N is an integer, and 3≤N<M.

In the first display mode, at least some emission wavelengths of the (M−N) types of primary color pixels in the black state are at least less than at least some light wavelengths of (N−1) types of primary color pixels in the bright state.

In the technical solution of the present disclosure, the value ranges of the driving components are determined according to the relationship equation between the color coordinate of the target color and the color coordinate of each primary color point, and the maximum value and/or the minimum value are taken within the value ranges of some driving components, which is conducive to reducing linear combinations of the M primary colors for synthesizing the target color, simplifying a calculation process and further determining a unique solution of each driving component; in addition, when some driving components are set to the maximum value and/or the minimum value within the value ranges, the first driving component D01 corresponding to the first primary color with the longest wavelength is set to the maximum value within the first value range, and/or the M-th driving component D0M corresponding to the M-th primary color with the shortest wavelength is set to the minimum value within the M-th value range, which are conducive to increasing a light flux of a primary color with a relatively large wavelength and decreasing a light flux of a primary color with a relatively small wavelength, thereby reducing the damage of short-wavelength light to the human eye.

It is to be understood that the content described in this section is neither intended to identify key or critical features of the embodiments of the present disclosure nor intended to limit the scope of the present disclosure. Other features of the present disclosure become easily understood through the description provided below.

### BRIEF DESCRIPTION OF DRAWINGS

To illustrate the technical solutions in the embodiments of the present disclosure more clearly, the drawings used in the description of the embodiments are briefly described below.

Apparently, the drawings described below illustrate part of the embodiments of the present disclosure, and those of ordinary skill in the art may obtain other drawings based on the drawings described below on the premise that no creative work is done.

FIG. 1 is a flowchart of an image conversion method according to an embodiment of the present disclosure.

FIG. 2 is a schematic diagram of a chromatic diagram according to an embodiment of the present disclosure.

FIG. 3 is a schematic diagram of another chromatic diagram according to an embodiment of the present disclosure.

FIG. 4 is a flowchart of another image conversion method according to an embodiment of the present disclosure.

FIG. 5 is a schematic diagram of another chromatic diagram according to an embodiment of the present disclosure.

FIG. 6 is a flowchart of another image conversion method according to an embodiment of the present disclosure.

FIG. 7 is a schematic diagram of another chromatic diagram according to an embodiment of the present disclosure.

FIG. 8 is a schematic diagram of another chromatic diagram according to an embodiment of the present disclosure.

FIG. 9 is a schematic diagram of another chromatic diagram according to an embodiment of the present disclosure.

FIG. 10 is a schematic diagram of another chromatic diagram according to an embodiment of the present disclosure.

FIG. 11 is a schematic diagram of another chromatic diagram according to an embodiment of the present disclosure.

FIG. 12 is a schematic diagram of another chromatic diagram according to an embodiment of the present disclosure.

FIG. 13 is a schematic diagram of another chromatic diagram according to an embodiment of the present disclosure.

FIG. 14 is a schematic diagram of another chromatic diagram according to an embodiment of the present disclosure.

FIG. 15 is a schematic diagram of another chromatic diagram according to an embodiment of the present disclosure.

FIG. 16 is a structure diagram of an image conversion apparatus according to an embodiment of the present disclosure.

FIG. 17 is a top view of a display device according to an embodiment of the present disclosure.

FIG. 18 is a top view of another display device according to an embodiment of the present disclosure.

FIG. 19 is a schematic diagram of another chromatic diagram according to an embodiment of the present disclosure.

FIG. 20 is a schematic diagram of another chromatic diagram according to an embodiment of the present disclosure.

FIG. 21 is a schematic diagram of another chromatic diagram according to an embodiment of the present disclosure.

FIG. 22 is a top view of another display device according to an embodiment of the present disclosure.

FIG. 23 is a top view of another display device according to an embodiment of the present disclosure.

FIG. 24 is a schematic diagram of another chromatic diagram according to an embodiment of the present disclosure.

FIG. 25 is a top view of another display device according to an embodiment of the present disclosure.

FIG. 26 is a top view of another display device according to an embodiment of the present disclosure.

FIG. 27 is a top view of another display device according to an embodiment of the present disclosure.

FIG. 28 is a top view of another display device according to an embodiment of the present disclosure.

FIG. 29 is a top view of another display device according to an embodiment of the present disclosure.

FIG. 30 is a schematic diagram of another chromatic diagram according to an embodiment of the present disclosure.

FIG. 31 is a schematic diagram of another chromatic diagram according to an embodiment of the present disclosure.

FIG. 32 is a top view of another display device according to an embodiment of the present disclosure.

FIG. 33 is a schematic diagram of another chromatic diagram according to an embodiment of the present disclosure.

FIG. 34 is a top view of another display device according to an embodiment of the present disclosure.

FIG. 35 is a top view of another display device according to an embodiment of the present disclosure.

FIG. 36 is a top view of another display device according to an embodiment of the present disclosure.

FIG. 37 is a top view of another display device according to an embodiment of the present disclosure.

### DETAILED DESCRIPTION

To make the technical solutions of the present disclosure better understood by those skilled in the art, the technical solutions in the embodiments of the present disclosure are described below clearly and completely in conjunction with the drawings in the embodiments of the present disclosure. Apparently, the embodiments described below are part, not all, of the embodiments of the present disclosure. Based on the embodiments of the present disclosure, all other embodiments obtained by those of ordinary skill in the art are within the scope of the present disclosure on the premise that no creative work is done.

It is to be noted that terms such as “first” and “second” in the description, claims, and drawings of the present disclosure are used for distinguishing between similar objects and are not necessarily used for describing a particular order or sequence. It is to be understood that data used in this manner are interchangeable where appropriate so that the embodiments of the present disclosure described herein can be implemented in order not illustrated or described herein. In addition, terms “comprising”, “including” and any variation thereof are intended to encompass a non-exclusive inclusion. For example, a process, method, system, product, or device that includes a series of steps or units not only includes the expressly listed steps or units, but may also include other steps or units that are not expressly listed or are inherent to such a process, method, product, or device.

According to BACKGROUND, a traditional display generally has three primary colors: red, green and blue. Coordinates of primary color points of the three primary colors (red, green and blue) in a chromatic diagram (a CIE chromatic diagram) are (Xr, Yr), (Xg, Yg) and (Xb, Yb), respectively. According to chromaticity formulas of X=x/(x+y+z), Y=y/(x+y+z), Z=z/(x+y+z) and X+Y+Z=1, color coordinates of the three primary colors (red, green and blue) can be obtained: (Xr, Yr, Zr), (Xg, Yg, Zg) and (Xb, Yb, Zb), where Xr denotes a relative light flux related to red in the red primary color, Yr denotes a relative light flux related to green in the red primary color, and Zr denotes a relative light flux related to blue in the red primary color. The relative light flux (Xr, Yr, Zr) is a value obtained after the light fluxes of the three colors (red, green and blue) are normalized. Similarly, Xg, Yg and Zg denote relative light fluxes related to the three colors (red, green and blue) in the green primary color, respectively, and Xb, Yb and Zb denote relative light fluxes related to the three colors (red, green and blue) in the blue primary color.

It is to be noted that the three colors (red, green and blue) are not equivalent to the three primary colors (red, green and blue). The red primary color only represents one of the primary colors of the display and does not represent red. Red is a color instead of a primary color. The red saturation in the red primary color may not be 100% (red is impure), and the red primary color may also include a small amount of green and blue, but the red content is the largest. In an ideal state, when the red saturation in the red primary color is 100% (the red purity is very high), it can be approximately considered that Xr=1 and Yr=Zr=0. Similarly, the green primary color only represents one of the primary colors of the display and does not represent green, and the blue primary color only represents one of the primary colors of the display and does not represent blue.

If it is expected to synthesize a target color, a coordinate (X0, Y0) of a target color point of the target color in the chromatic diagram can be acquired, and a color coordinate (X0, Y0, Z0) can be obtained according to the chromaticity formulas. A relationship between the color coordinate of the target color and the color coordinate of each primary color is as follows: (X0, Y0, Z0)=Dr*(Xr, Yr, Zr)+Dg*(Xg, Yg, Zg)+Db*(Xb, Yb, Zb), where X0, Y0 and Z0 denote relative light fluxes related to the three colors (red, green and blue) in the target color, respectively, and Dr, Dg and Db denote driving components related to the three primary colors (red, green and blue) in the target color, respectively. The driving component is a relative light flux of each primary color in the display, that is, a value obtained after the light fluxes of the three primary colors (red, green and blue) are normalized. The primary colors are mixed according the driving components to obtain the target color, that is, Dr*Xr+Dg*Xg+Db*Xb=X0, Dr*Yr+Dg*Yg+Db*Yb=Y0, and Dr*Zr+Dg*Zg+Db*Zb=Z0. In this manner, the target color can be obtained, and Dr, Dg and Db have unique solutions. For a three-primary-color display, a unique linear combination of the red primary color, the green primary color and the blue primary color for synthesizing the target color can be determined according to the unique solutions of Dr, Dg and Db.

However, for a four-primary-color display, it is assumed that a fourth primary color different from red, green and blue is added on the basis of the three primary colors (red, green and blue), a coordinate of a primary color point of the fourth primary color in the chromatic diagram is (X4, Y4), and a color coordinate (X4, Y4, Z4) can be obtained according to the chromaticity formulas, where X4, Y4 and Z4 represent relative light fluxes related to the three colors (red, green and blue) in the fourth primary color, respectively. A relationship between the color coordinate of the target color and the color coordinate of each primary color is as follows: (X0, Y0, Z0)=Dr*(Xr, Yr, Zr)+Dg*(Xg, Yg, Zg)+Db*(Xb, Yb, Zb)+D04*(X4, Y4, Z4), where D04 denotes a driving component of the fourth primary color in the target color. If it is expected to synthesize the target color, Dr*Xr+Dg*Xg+Db*Xb+D04*X4=X0, Dr*Yr+Dg*Yg+Db*Yb+D04*Y4=Y0, and Dr*Zr+Dg*Zg+Db*Zb+D04*Z4=Z0. The three equations have four unknown driving components, and the driving components Dr, Dg, Db and D04 have multiple solutions.

For the four-primary-color display, Dr, Dg, Db and D04 have multiple solutions, and there are countless linear combinations of the red primary color, the green primary color, the blue primary color and the fourth primary color for synthesizing the target color. Similarly, for a display with more than four primary colors, the driving components also have multiple solutions, and there are also countless linear combinations of the primary colors for synthesizing the target color. However, in practical application, only one of the linear combinations can be used for displaying the target color. Therefore, how to determine the unique and better solution of each driving component is an urgent technical problem to be solved at present.

To solve the above technical problem, embodiments of the present disclosure provide an image conversion method. The method includes: acquiring a target color, and determining a target color point of the target color in a chromatic diagram, where the chromatic diagram includes M primary color points, the M primary color points correspond to M primary colors, Mis an integer, and M≥4; defining M driving components (D01, D02, . . . and D0M) corresponding to the M primary colors and a relationship equation between a color coordinate (X0, Y0, Z0) of the target color point and a color coordinate (Xi, Yi, Zi) of each primary color point: (X0, Y0, Z0)=D01*(X1, Y1, Z1)+D02*(X2, Y2, Z2)+ . . . +D0M*(XM, YM, ZM), where 1≤i≤M, and i is an integer; determining a first value range of a first driving component D01 according to the relationship equation, setting the first driving component D01 to a maximum value within the first value range, and determining values of remaining (M−1) driving components; and/or determining an M-th value range of an M-th driving component D0M according to the relationship equation, setting the M-th driving component D0M to a minimum value within the M-th value range, and determining values of remaining (M−1) driving components. The M primary colors include a first primary color, a second primary color, . . . and an M-th primary color, a wavelength of the first primary color is greater than at least some wavelengths of the second primary color to the M-th primary color, and a wavelength of the M-th primary color is less than at least some wavelengths of the first primary color to an (M−1)-th primary color.

Through the above technical solution, the value ranges of the driving components are determined according to the relationship equation between the color coordinate of the target color and the color coordinate of each primary color point, and the maximum value and/or the minimum value are taken within the value ranges of some driving components, which is conducive to reducing linear combinations of the M primary colors for synthesizing the target color, simplifying a calculation process and further determining a unique solution of each driving component. In addition, when some driving components are set to the maximum value and/or the minimum value within the value ranges, the first driving component D01 corresponding to the first primary color with the longest wavelength is set to the maximum value within the first value range, and/or the M-th driving component D0M corresponding to the M-th primary color with the shortest wavelength is set to the minimum value within the M-th value range, which are conducive to increasing a light flux of a primary color with a relatively large wavelength and decreasing a light flux of a primary color with a relatively small wavelength, thereby reducing the damage of short-wavelength light to the human eye.

The preceding is a core idea of the present disclosure. Based on the embodiments of the present disclosure, all other embodiments obtained by those of ordinary skill in the art are within the scope of the present disclosure on the premise that no creative work is done. Technical solutions of the embodiments of the present disclosure are described clearly and completely hereinafter in conjunction with the drawings in the embodiments of the present disclosure.

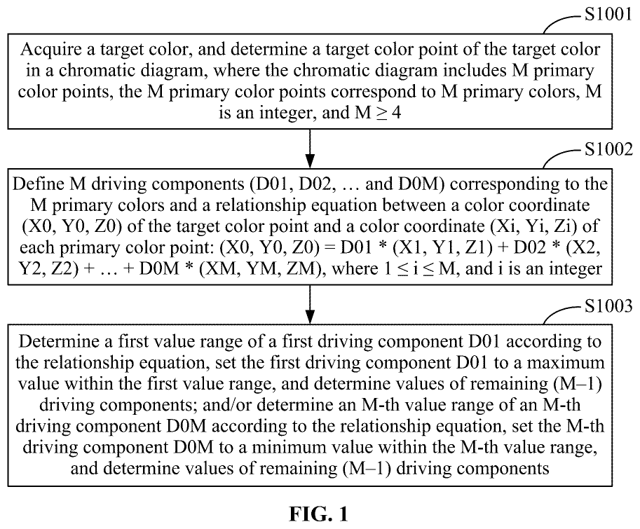

FIG. 1 is a flowchart of an image conversion method according to an embodiment of the present disclosure. Referring to FIG. 1, the image conversion method includes the steps described below.

In 1001, a target color is acquired, and a target color point of the target color in a chromatic diagram is determined, where the chromatic diagram includes M primary color points, the M primary color points correspond to M primary colors, Mis an integer, and M≥4.

The M primary color points correspond to M primary colors of a display, that is, M types of primary color pixels, and each type of primary color pixel can correspondingly emit light of one type of primary color. The M primary colors may include single-color primary colors, for example, primary colors such as red (R), yellow (Y), green (G), cyan (C) and blue (B), and the M primary colors may further include mixed-color primary colors, for example, primary colors such as white (W). A wavelength of the single-color primary color may be a certain specific wavelength value or a certain wavelength range, and wavelengths of different single-color primary colors at least partially do not overlap with each other. A wavelength of the mixed-color primary color may be multiple specific wavelength values, or may also be one or more wavelength ranges. The wavelength of the mixed-color primary color may overlap wavelengths of other single-color primary colors.

In one embodiment of the present disclosure, the wavelength of the primary color may be a peak wavelength or crest wavelength of a luminescent spectrum of a corresponding primary color pixel. The single-color primary color may include at least one peak wavelength and/or at least one crest wavelength, and the mixed-color primary color may include multiple peak wavelengths or multiple crest wavelengths. In another embodiment of present disclosure, the wavelength of the primary color may further be a wavelength range in the luminescent spectrum of the corresponding primary color pixel that is greater than a preset brightness threshold or a wavelength range that is greater than a preset percentage of the maximum brightness amplitude. In another embodiment of present disclosure, wavelengths of different single-color primary colors do not overlap with each other.

The M primary colors include a first primary color, a second primary color, . . . and an M-th primary color, a wavelength of the first primary color is greater than at least some wavelengths of the second primary color to the M-th primary color, and a wavelength of the M-th primary color is less than at least some wavelengths of the first primary color to an (M−1)-th primary color, that is, the first primary color is a single-color primary color with the largest wavelength among all the primary colors, and the M-th primary color is a single-color primary color with the smallest wavelength among all the primary colors. In one embodiment of present disclosure, the first primary color is a red primary color, and the M-th primary color is a blue primary color. A wavelength of the red primary color may be greater than the wavelengths of all the other single-color primary colors, and greater than at least part of the wavelength of the mixed primary color. A wavelength of the blue primary color may be less than the wavelengths of all the other single-color primary colors and less than at least part of the wavelength of the mixed primary color.

In 1002, M driving components (D01, D02, . . . and D0M) corresponding to the M primary colors and a relationship equation between a color coordinate (X0, Y0, Z0) of the target color point and a color coordinate (Xi, Yi, Zi) of each primary color point: (X0, Y0, Z0)=D01*(X1, Y1, Z1)+D02*(X2, Y2, Z2)+ . . . +D0M*(XM, YM, ZM) are defined, where 1≤i≤M, and i is an integer.

The color coordinate (X0, Y0, Z0) of the target color point may denote the target color, and X0, Y0 and Z0 denote relative light fluxes related to the three colors (red, green and blue) in the target color, respectively. (Xi, Yi, Zi) is a color coordinate of an i-th primary color point, and Xi, Yi and Zi denote relative light fluxes related to the three colors (red, green and blue) in an i-th primary color, respectively. Di is a driving component of the i-th primary color, 1≤i≤M, and i is an integer. The driving component Di refers to a relative light flux corresponding to the i-th primary color, or may be relative brightness of a primary color pixel corresponding to the i-th primary color. When the driving component Di corresponding to the i-th primary color is zero, it indicates that the relative light flux of the i-th primary color is zero, that is, the primary color pixel corresponding to the i-th primary color does not emit light.

It is to be noted that the driving component and the drive voltage are different definitions. Please be careful not to confuse the driving component and the drive voltage. For the same primary color and the same primary color pixel corresponding to the same primary color, driving component refers to a relative light flux corresponding to the primary color, or may be relative brightness of the primary color pixel corresponding to the primary color. Drive voltage refers to a voltage required by the operation of the primary color pixel. The primary color pixel can display a corresponding grayscale, that is, the corresponding brightness, according to the drive voltage. For the same primary color and the same primary color pixel corresponding to the same primary color, when the driving component is zero, the primary color pixel does not emit light, but it does not indicate that the drive voltage is zero. Of course, the drive voltage may also be zero without limitation, that is, when the driving component is zero, the drive voltage may be any value within a reasonable value range. When the drive voltage is zero, it does not indicate that the primary color pixel does not emit light. The primary color pixel may or may not emit light without limitation, that is, when the drive voltage is zero, the driving component may also be any value within a reasonable value range.

In 1003, a first value range of a first driving component D01 is determined according to the relationship equation, the first driving component D01 is set to a maximum value within the first value range, and values of remaining (M−1) driving components are determined; and/or an M-th value range of an M-th driving component D0M is determined according to the relationship equation, the M-th driving component D0M is set to a minimum value within the M-th value range, and values of remaining (M−1) driving components are determined.

Specifically, M≥4. According to the relationship equation between the color coordinate of the target color and the color coordinate of each primary color: (X0, Y0, Z0)=D01*(X1, Y1, Z1)+D02*(X2, Y2, Z2)+ . . . +D0M*(XM, YM, ZM), it can be seen that D01*X1+D02*X2+ . . . +D0M*XM=X0, D01*Y1+D02*Y2+ . . . +D0M*YM=Y0 and D01*Z1+D02*Z2+ . . . +D0M*ZM=Z0, and D01, D02, . . . and D0M have multiple solutions. Since each driving component is a value obtained after a light flux of each primary color is normalized, the driving component corresponding to each primary color is greater than or equal to 0, and less than or equal to 1. The sum of the driving components corresponding to all the primary colors is 1, that is, 0≤Di≤1, D01+ . . . +D0M=1, 1≤i≤M, and i is an integer. In conjunction with the relationship equation between the color coordinate of the target color and the color coordinate of each primary color, a value range of each driving component can be determined, or value ranges of at least some driving components can be determined. For example, at least the first value range of the first driving component D01 and/or the M-th value range of the M-th driving component D0M can be determined, and the first driving component D01 and/or the M-th driving component D0M can be determined according to the maximum value and/or the minimum value within the value ranges. On the one hand, it is conducive to reducing linear combinations of the M primary colors for synthesizing the target color, simplifying a calculation process and further determining unique solutions of D01, D02, . . . and D0M. On the other hand, whether the first driving component D01 is set to the maximum value within the first value range or the M-th driving component D0M is set to the minimum value within the M-th value range, it is conducive to increasing a light flux of a primary color with a relatively large wavelength and decreasing a light flux of a primary color with a relatively small wavelength, thereby reducing the damage of short-wavelength light to the human eye.

For example, to acquire the target color, an input signal of the target color can be acquired, the input signal can be converted into a corresponding RGB brightness input value, and the target color corresponding to the input signal and the color coordinate (X0, Y0, Z0) of the target color can be determined according to the RGB brightness input value. After the color coordinate (X0, Y0, Z0) of the target color is acquired, the relationship equation can be defined according to the color coordinate (Xi, Yi, Zi) of each primary color point stored in advance to determine the value range of the driving component Di corresponding to each primary color point. When M=4, the first driving component D01 is determined as the maximum value within the value range and/or a fourth driving component D04 is determined as a minimum value within a value range so that the remaining three driving components can have unique solutions, thereby determining a unique solution of each driving component. Thereafter, a brightness output value of each primary color can be determined according to each driving component and a preset brightness parameter. The brightness parameter can be predetermined according to an actual need, and in specific implementation, the brightness parameter can be changed to adjust the brightness output value of each primary color to obtain the preset brightness of the target color.

In addition, when M≥5, after the first driving component D01 is determined as the maximum value within the value range and/or the fourth driving component D04 is determined as the minimum value within the value range, other driving components may continue to be determined as maximum values and/or minimum values within a value range until three driving components remain. Then, according to the relationship equation between the color coordinate (X0, Y0, Z0) of the target color and the color coordinate (Xi, Yi, Zi) of each primary color point and the values of the determined driving components, unique solutions of the remaining three driving components can be determined, and a unique solution of each driving component can be determined.

In the embodiment of the present disclosure, four or more primary colors are set, which is conducive to increasing a synthetic color gamut and achieving more colors, thereby providing rich color performance and presenting more vibrant and vivid colors. The value ranges of the driving components are determined according to the relationship equation between the color coordinate of the target color and the color coordinate of each primary color point, and the maximum value and/or the minimum value are taken within the value ranges of some driving components, which is conducive to reducing linear combinations of the M(M≥3) primary colors for synthesizing the target color, simplifying a calculation process and further determining a unique solution of each driving component. In addition, when some driving components are set to the maximum value and/or the minimum value within the value ranges, the first driving component D01 corresponding to the first primary color with the longest wavelength is set to the maximum value within the first value range, and/or the M-th driving component D0M corresponding to the M-th primary color with the shortest wavelength is set to the minimum value within the M-th value range, which are conducive to increasing a light flux of a primary color with a relatively large wavelength and decreasing a light flux of a primary color with a relatively small wavelength, thereby reducing the damage of short-wavelength light to the human eye.

In the embodiment of the present disclosure, the target color point includes a first target color point. When the target color point is the first target color point, the M-th driving component D0M=0.

The M primary color points in the chromatic diagram may form multiple sub-regions, and the sub-region is delimited by at least three primary color points and at most (M−1) primary color points. A first target region is a sub-region enclosed by multiple primary color points excluding an M-th primary color point corresponding to the M-th primary color, and the first target color point may be any color point located in the first target region.

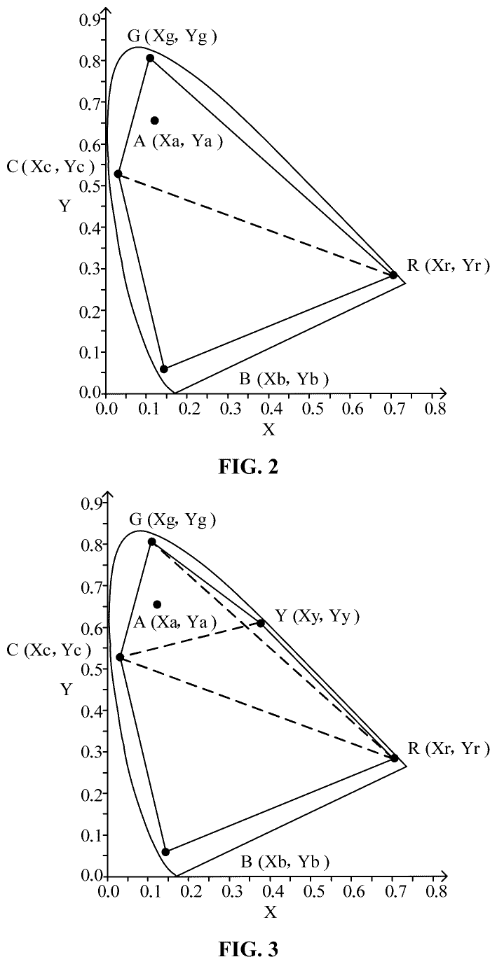

For example, M=4 is used as an example. FIG. 2 is a schematic diagram of a chromatic diagram according to an embodiment of the present disclosure. Referring to FIG. 2, the chromatic diagram includes four primary color points: red (R), green (G), cyan (C) and blue (B). A fourth primary color is the B primary color, and the fourth driving component D04 is a driving component of the B primary color. An RGCB region enclosed by the four primary color points R, G, C and B is a color gamut of colors that can be synthesized by the four primary colors R, G, C and B. Any target color in the color gamut can be synthesized by one or more of the four primary colors R, G, C and B. For example, a color on a line connecting the R primary color point and the C primary color point can be synthesized by the R primary color and the C primary color, and a color in an RGC region enclosed by the R primary color point, the G primary color point and the C primary color point can be synthesized by the R primary color, the G primary color and the C primary color. The RGC region is the first target region, and the first target color point A may be any color point located in the RGC region. When the target color point is the first target color point A, the fourth driving component D04 of the B primary color may be set to zero, the target color corresponding to the target color point may be synthesized only by the R primary color, the G primary color and the C primary color, and three driving components corresponding to the R primary color, the G primary color and the C primary color have unique solutions. When the target color is synthesized, the fourth driving component D04 of the B primary color is zero, that is, a relative light flux of the B primary color is zero, and a B primary color pixel in the display may not emit light.

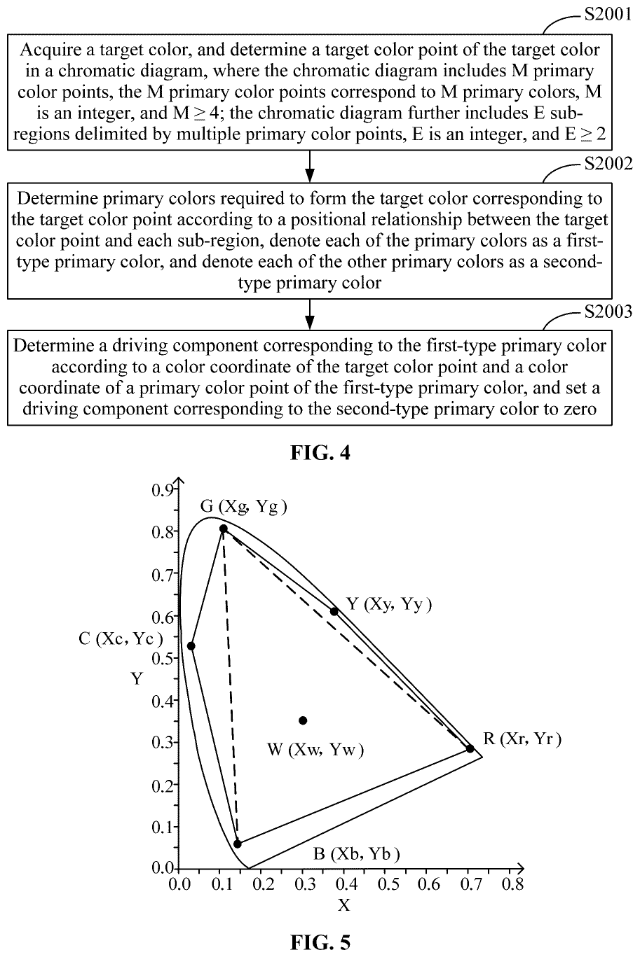

For example, M=5 is used as an example. FIG. 3 is a schematic diagram of another chromatic diagram according to an embodiment of the present disclosure. Referring to FIG. 3, the chromatic diagram includes five primary color points: red (R), yellow (Y), green (G), cyan (C) and blue (B). A fifth primary color is the B primary color, and a fifth driving component D05 is a driving component of the B primary color. An RYG region, an RGC region, an RYC region, a YGC region and an RYGC region are all first target regions, and the first target color point A may be any color point located in the RYG region, the RGC region, the YGC region and the RYGC region. When the target color point is the first target color point A, the fifth driving component D05 of the B primary color may be set to zero, the target color corresponding to the target color point may be synthesized by at least some of the R primary color, the Y primary color, the G primary color and the C primary color, and four driving components corresponding to the R primary color, the Y primary color, the G primary color and the C primary color may have multiple solutions. However, regardless of the solutions of the four driving components corresponding to the R primary color, the Y primary color, the G primary color and the C primary color, when the target color is synthesized, the fifth driving component D05 of B is zero, that is, a relative light flux of the B primary color is zero, and a B primary color pixel in the display does not emit light.

In this manner, when rich target colors are synthesized, target color points corresponding to some of the target colors are located in the first target region, that is, first target color points are the target color points corresponding to at least the target colors. In this case, the synthesis of the target colors may not use the M-th primary color with the shortest wavelength so that an M-th primary color pixel with the shortest light wavelength in the display does not emit light correspondingly. Moreover, the M-th primary color with the shortest wavelength in the display is generally a blue primary color. In this manner, blue light can be reduced effectively, thereby achieving an effect of removing blue light, and reducing the damage of blue light to the human eye.

As can be seen from the above content, for the M primary colors, if the target color is expected to be synthesized and there are M unknown driving components, the first driving component D01 or the M-th driving component D0M can be determined according to the above image conversion method. For the case of M=4, after the first driving component M1 or the M-th driving component D0M is determined, three unknown driving components remain, and in this case, the remaining three driving components can have unique solutions so that unique solutions of D01, D02, . . . and D0M can be determined. For the case of M≥5, after the first driving component M1 or the M-th driving component D0M is determined, (M−1) unknown driving components remain, (M−1) is greater than three, and the remaining (M−1) driving components have multiple solutions. For the remaining (M−1) driving components, a maximum value and/or a minimum value within value ranges may continue to be determined to determine unique solutions. However, how to determine the unique solutions specifically is not limited.

In one embodiment of present disclosure, when M≥5; determining the first value range of the first driving component D01 according to the relationship equation, setting the first driving component D01 to the maximum value within the first value range, and determining the values of the remaining (M−1) driving components include: determining the first value range of the first driving component D01 according to the relationship equation, and setting the first driving component D01 to the maximum value within the first value range; sequentially setting the values of the remaining driving components in ascending order of numbers until three driving components are remained; determining the remaining three driving components according to the relationship equation and the set values of the driving components.

determining the M-th value range of the M-th driving component D0M according to the relationship equation, setting the M-th driving component D0M to the minimum value within the M-th value range, and determining the values of the remaining (M−1) driving components include: determining the M-th value range of the M-th driving component D0M according to the relationship equation, and setting the M-th driving component D0M to the minimum value within the M-th value range; sequentially setting the values of the remaining driving components in descending order of numbers until three driving components are remained; determining the remaining three driving components according to the relationship equation and the set values of the driving components.

in ascending order of numbers, wavelengths of primary colors corresponding to the driving components D01, D02, . . . and D0M decrease sequentially. The first driving component D01 corresponds to the first primary color, and the wavelength of the first primary color is greater than wavelengths of other primary colors; the second driving component D02 corresponds to the second primary color, and the wavelength of the second primary color is greater than wavelengths of a third primary color to the M-th primary color; a third driving component D03 corresponds to the third primary color, and a wavelength of the third primary color is greater than wavelengths of the fourth primary color to the M-th primary color; . . . . When M=5, the first primary color to the M-th primary color may be a red (R) primary color, a yellow (Y) primary color, a green (G) primary color, a cyan (C) primary color and a blue (B) primary color, respectively.

According to the relationship equation between the color coordinate of the target color and the color coordinate of each primary color point, the value range of the first driving component D01 corresponding to the R primary color can be determined, and the first driving component D01 can be set to the maximum value. According to the relationship equation and the first driving component D01, a value range of the second driving component D02 corresponding to the Y primary color can be determined, and the second driving component D02 can be set to a maximum value. In this case, three driving components (D03, D04 and D05) corresponding to the G primary color, the C primary color and the B primary color remain, and the remaining three driving components (D03, D04 and D05) have unique solutions, thereby determining unique solutions of D01, D02, D03, D04 and D05.

In the embodiment of the present disclosure, according to the relationship equation between the color coordinate of the target color and the color coordinate of each primary color point, a value range of the fifth driving component D05 corresponding to the B primary color can be determined, and the fifth driving component D05 can be set to a minimum value. According to the relationship equation and the fifth driving component D05, the value range of the fourth driving component D04 corresponding to the C primary color can be determined, and the fourth driving component D04 can be set to the minimum value. In this case, three driving components (D01, D02 and D03) corresponding to the R primary color, the Y primary color and the G primary color remain, and the remaining three driving components (D01, D02 and D03) have unique solutions, thereby determining unique solutions of D01, D02, D03, D04 and D05.

The driving components corresponding to the primary colors with a relatively large wavelength as the maximum values within the value ranges are set sequentially or the driving components corresponding to the primary colors with a relatively small wavelength as the minimum values within the value ranges are set sequentially until three unknown driving components remain so that the remaining three unknown driving components can have unique solutions, and unique solutions of the driving components D01, D02, . . . and D0M can be determined, which is conducive to increasing a relative light flux of a primary color with a large wavelength that causes less damage to the human eye and decreasing a relative light flux of a primary color with a small wavelength that causes more damage to the human eye, thereby achieving the effect of removing blue light and effectively reducing the damage to the human eye.

In another embodiment of present disclosure, when M=5; determining the first value range of the first driving component D01 according to the relationship equation, setting the first driving component D01 to the maximum value within the first value range, and determining the values of the remaining (M−1) driving components include: determining the first value range of the first driving component D01 according to the relationship equation, and setting the first driving component D01 to the maximum value within the first value range; determining a fifth value range of a fifth driving component D05 according to the relationship equation and the first driving component D01, and setting the fifth driving component D05 to a minimum value within the fifth value range; determining the remaining three driving components according to the relationship equation, the first driving component D01 and the fifth driving component D05.

And/or, determining the M-th value range of the M-th driving component D0M according to the relationship equation, setting the M-th driving component D0M to the minimum value within the M-th value range, and determining the values of the remaining (M−1) driving components include: determining the fifth value range of the fifth driving component D05 according to the relationship equation, and setting the fifth driving component D05 to the minimum value within the fifth value range; determining the first value range of the first driving component D01 according to the relationship equation and the fifth driving component D05, and setting the first driving component D01 to the maximum value within the first value range; determining remaining three driving components according to the relationship equation, the first driving component D01 and the fifth driving component D05.

Specifically, the first driving component D01 corresponds to the first primary color, and the wavelength of the first primary color is greater than at least some wavelengths of other primary colors; the fifth driving component D05 corresponds to the fifth primary color, and a wavelength of the fifth primary color is less than at least some wavelengths of other primary colors. In one embodiment of present disclosure, the first primary color may be a red primary color, and the fifth primary color may be a blue primary color. In a process of determining unique solutions of the driving components D01, D02, D03, D04 and D05, the first driving component D01 is the maximum value within the first value range, and the fifth driving component D05 is the minimum value within the fifth value range so that the remaining three driving components (D02, D03 and D04) have unique solutions. In this manner, the relative light flux of the primary color with a large wavelength that causes less damage to the human eye can also be increased, and the relative light flux of the primary color with a small wavelength that causes more damage to the human eye can also be decreased, thereby achieving the effect of removing blue light and effectively reducing the damage to the human eye.

In another embodiment of present disclosure, when M≥5; determining the M-th value range of the M-th driving component D0M according to the relationship equation, setting the M-th driving component D0M to the minimum value within the M-th value range, and determining the values of the remaining (M−1) driving components include: determining the M-th value range of the M-th driving component D0M according to the relationship equation, and setting the M-th driving component D0M to the minimum value within the M-th value range; determining a first value range of a first driving component D01 according to the relationship equation and the M driving component D0M, and setting the first driving component D01 to a minimum value within the first value range; determining remaining (M−2) driving components according to the relationship equation, the first driving component D01 and the M driving component D0M.

For example, the first driving component D01 corresponds to the first primary color, and the first primary color may be a red primary color; the M-th driving component D0M corresponds to the M-th primary color, and the M-th primary color may be a blue primary color. When M=5, after the fifth driving component D05 is the minimum value within the fifth value range and the first driving component D01 is determined as the minimum value within the first value range, three unknown driving components remain, and the remaining three driving components may have unique solutions. When M≥5, after the fifth driving component D05 is the minimum value within the fifth value range and the first driving component D01 is determined as the minimum value within the first value range, (M−2) unknown driving components remain, (M−2) is greater than three, and the remaining (M−2) driving components have multiple solutions. Among the remaining (M−2) driving components, a driving component corresponding to a primary color with a large wavelength may be set to a maximum value within a value range, and/or a driving component corresponding to a primary color with a small wavelength may be set to a minimum value within a value range, thereby determining unique solutions of the driving components.

Generally, the primary color with a relatively short wavelength corresponds to a primary color pixel with relatively high luminescence efficiency and causes more damage to the human eye, and the primary color with a relatively long wavelength corresponds to a primary color pixel with relatively low luminescence efficiency and causes less damage to the human eye. Setting the driving component of the primary color with the shortest wavelength to the minimum value within the value range and setting the driving component of the primary color with the lowest luminescence efficiency to the minimum value within the value range can reduce the light flux of the primary color with a short wavelength and increase the light flux of the primary color with relatively low luminescence efficiency. In this manner, the damage to the human eye is reduced, and low power consumption is facilitated.

Based on the same inventive concept, FIG. 4 is a flowchart of another image conversion method according to an embodiment of the present disclosure. Referring to FIG. 4, the image conversion method includes the steps described below.

In S2001, a target color is acquired, and a target color point of the target color in a chromatic diagram is determined, where the chromatic diagram includes M primary color points, the M primary color points correspond to M primary colors, M is an integer, and M≥4; the chromatic diagram further includes E sub-regions delimited by multiple primary color points, E is an integer, and E≥2.

The M primary color points correspond to M primary colors of a display, that is, M types of primary color pixels, and each type of primary color pixel can correspondingly emit light of one type of primary color. The M primary colors include a first primary color, a second primary color, . . . and an M-th primary color, and a wavelength of the M-th primary color is less than at least some wavelengths of the first primary color to an (M−1)-th primary color. In one embodiment of present disclosure, the M-th primary color may be a blue primary color.

The sub-region is delimited by at least three primary color points and at most (M−1) primary color points, and at least one sub-region is delimited by multiple primary color points excluding an M-th primary color point corresponding to the M-th primary color. For different sub-regions, the numbers of primary color points used for delimitation may be the same or different and are not limited in the present disclosure. In addition, among at least part of the sub-regions, two sub-regions do not overlap with each other, that is, at least one of the multiple primary color points for delimiting different sub-regions is different. In one embodiment of present disclosure, edges of adjacent sub-regions may overlap with each other, but regions within the edges may not overlap with each other. In another embodiment of present disclosure, a combination of all the sub-regions can cover the largest region enclosed by all the primary color points.

In S2002, primary colors required to form the target color corresponding to the target color point are determined according to a positional relationship between the target color point and each sub-region, each of the primary colors is denoted as a first-type primary color, and each of the other primary colors is denoted as a second-type primary color.

The first-type primary color refers to a primary color required for synthesizing the target color and is also a primary color required for delimiting the same sub-region. As can be seen from the fact that the sub-region may be delimited by at least three primary color points and at most (M−1) primary color points, the first-type primary color may include at least three primary colors and at most (M−1) primary colors. In one embodiment of present disclosure, the first-type primary color includes N primary colors, and the second-type primary color includes (M−N) primary colors, that is, the N primary colors may be first-type primary colors, and the (M−N) primary colors may be second-type primary colors, where N is an integer greater than 3 and less than M.

Specifically, according to a color coordinate of the target color point and a color coordinate of each primary color point, a sub-region where the target color point is located can be determined, and primary colors corresponding to multiple primary color points for delimiting the sub-region can be determined as the primary colors required for synthesizing the target color, that is, each of the primary colors corresponding to the multiple primary color points for delimiting the sub-region is denoted as the first-type primary color, and each of the other primary colors is denoted as the second-type primary color.

In S2003, a driving component corresponding to the first-type primary color is determined according to a color coordinate of the target color point and a color coordinate of a primary color point of the first-type primary color, and a driving component corresponding to the second-type primary color is set to zero.

Specifically, the driving component corresponding to the first-type primary color and a relationship equation between the color coordinate of the target color point and the color coordinate of the first-type primary color are defined, and the driving component corresponding to the first-type primary color can be determined according to the relationship equation. Moreover, the driving component corresponding to the second-type primary color is set to zero, thereby determining unique solutions of driving components D01, D02, . . . and D0M corresponding to all the primary colors.

For example, the first-type primary color includes N primary colors, where Nis an integer greater than 3 and less than M. When M=4, N=3. The first-type primary color includes three primary colors. According to the relationship equation between the color coordinate of the target color point and the color coordinate of the first-type primary color, a unique solution of the driving component corresponding to the first-type primary color can be determined, and other primary colors are all second-type primary colors, that is, driving components corresponding to the other primary colors are all zero, and the unique solutions of the driving components corresponding to all the primary colors can be determined.

When M=5, N=3 and/or 4. If N=3, the driving component corresponding to the first-type primary color has a unique solution. If N=4, the driving component corresponding to the first-type primary color has multiple solutions. A driving component corresponding to a first-type primary color with a relatively large wavelength may be set to a maximum value within a value range, and/or a driving component corresponding to a first-type primary color with a relatively small wavelength may be set to a minimum value within a value range, thereby determining a unique solution of the driving component corresponding to the first-type primary color.

Since at least some sub-regions are delimited by the multiple primary color points excluding the M-th primary color point corresponding to the M-th primary color, it can be seen that when rich target colors are synthesized, primary colors required for synthesizing at least some target colors do not include the M-th primary color. In this case, the M-th primary color is the second-type primary color, and a driving component corresponding to the M-th primary color is zero, that is, a light flux corresponding to the M-th primary color is zero so that an M-th primary color pixel with the shortest light wavelength in the display does not emit light correspondingly.

In the embodiment of the present disclosure, four or more primary colors are set, which is conducive to increasing a color gamut and achieving more colors, thereby providing rich color performance and presenting more vibrant and vivid colors; multiple sub-regions are delimited in the chromatic diagram, and each sub-region is delimited by multiple primary color points so that multiple primary colors required to form the target color can be determined according to the region where the target color point is located and the driving components of other primary colors are zero, thereby simplifying a calculation process and further determining a unique solution of each driving component; in addition, at least some sub-regions are delimited by the multiple primary color points excluding the M-th primary color point corresponding to the M-th primary color so that the formation of some target colors does not need the M-th primary color, that is, the light flux of the M-th primary color with the shortest wavelength is zero. Moreover, the M-th primary color with the shortest wavelength in the display is generally a blue primary color. In this manner, blue light can be reduced effectively, thereby achieving an effect of removing blue light, and reducing the damage of blue light to the human eye.

Optionally, the M primary color points of the chromatic diagram at least include a red (R) primary color point, a green (G) primary color point and a blue (B) primary color point; at least one of the M primary color points of the chromatic diagram is located outside an RGB region delimited by the R primary color point, the G primary color point and the B primary color point in the chromatic diagram.

For example, FIG. 5 is a schematic diagram of another chromatic diagram according to an embodiment of the present disclosure. Referring to FIG. 5, in addition to the R primary color point, the G primary color point and the B primary color point, the M primary color points of the chromatic diagram may further include a yellow (Y) primary color point and/or a cyan (C) primary color point. M=5 is used as an example. The chromatic diagram may include five primary color points of R, Y, G, C and B, and both the Y primary color point and the C primary color point may be located outside the RGB region delimited by the R primary color point, the G primary color point and the B primary color point. An area of an RYGCB region delimited by the five primary color points of R, Y, G, C and B covers and is greater than an area of the RGB region. In this manner, compared with conventional three primary colors of R, G and B, when colors corresponding to at least one primary color point located outside the RGB region is added in addition to the three primary colors of R, G and B, the color gamut can be effectively increased, and more colors can be achieved, thereby providing rich color performance.

It is to be noted that in other optional embodiments, in addition to the R primary color point, the G primary color point and the B primary color point, at least some primary color points of the chromatic diagram may be located within the RGB region. For example, the chromatic diagram may further include a W primary color point, and the W primary color point may be located within the RGB region.

Optionally, the M primary color points of the chromatic diagram at least include a red (R) primary color point, a green (G) primary color point and a blue (B) primary color point, the R primary color point, the G primary color point and the B primary color point correspond to an R primary color, a G primary color and a B primary color, respectively, and wavelengths of the R primary color, the G primary color and the B primary color decrease in sequence; in addition to the R primary color point, the G primary color point and the B primary color point, the M primary color points of the chromatic diagram further include at least one newly added primary color point; a wavelength of a newly added primary color corresponding to the at least one newly added primary color point is located between the wavelength of the G primary color and the wavelength of the B primary color.

Specifically, a sub-region can be delimited by the newly added primary color point and primary color points excluding the B primary color point. The sub-region is delimited by multiple primary color points excluding the B primary color point so that the formation of some target colors does not need the B primary color. In other words, when some target colors are synthesized, the B primary color can be replaced by the newly added primary color point. The wavelength of the newly added primary color is located between the wavelength of the G primary color and the wavelength of the B primary color. On the one hand, it is conducive to increasing an area of a sub-region delimited by the newly added primary color point, the R primary color point and the G primary color point, thereby controlling a driving component corresponding to the B primary color to be zero when more target colors are synthesized to enhance the effect of removing blue light and further reduce the damage to the human eye. On the other hand, in practical application, a light-emitting material emitting the light between the wavelength of G and the wavelength of B has better optical performance, higher tolerance to a material defect and a relatively low requirement for preparation and is easier to prepare, and a light-emitting device emitting the light between the wavelength of G and the wavelength of B has relatively high luminescence efficiency. Compared with the use of a newly added primary color with another wave band, replacing the B primary color with the newly added primary color whose wavelength is located between the wavelength of G and the wavelength of B is more conducive to low power consumption.

In one embodiment of present disclosure, in addition to the R primary color point, the G primary color point and the B primary color point, the newly added primary color point may be a cyan (C) primary color point, the C primary color point corresponds to a C primary color, and a wavelength of the C primary color is located between the wavelength of the G primary color and the wavelength of the B primary color.

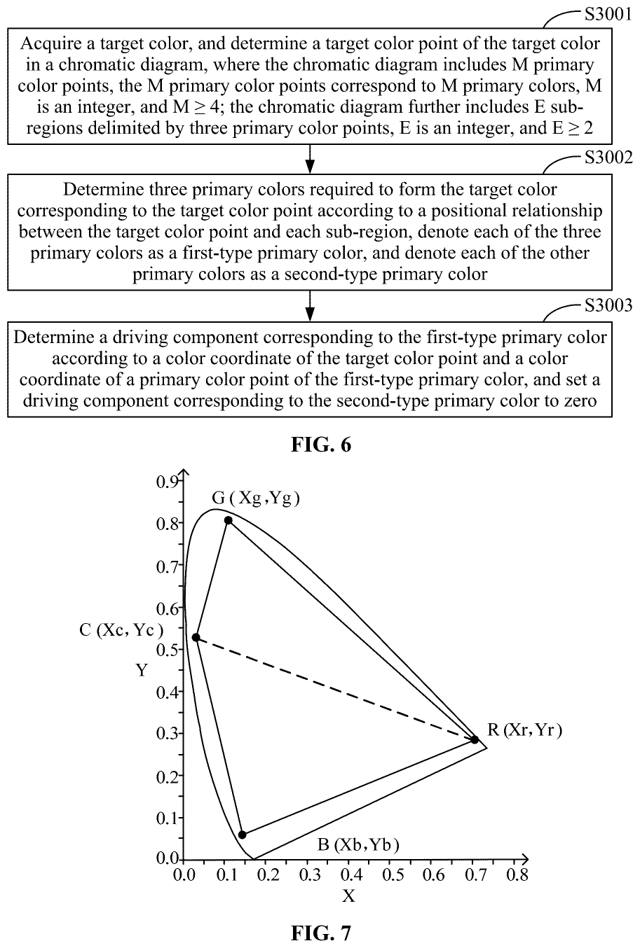

Optionally, FIG. 6 is a flowchart of another image conversion method according to an embodiment of the present disclosure. Referring to FIG. 6, the image conversion method includes the steps described below.

In S3001, a target color is acquired, and a target color point of the target color in a chromatic diagram is determined, where the chromatic diagram includes M primary color points, the M primary color points correspond to M primary colors, M is an integer, and M≥4. The chromatic diagram further includes E sub-regions delimited by three primary color points, E is an integer, and E≥2.

In S3002, three primary colors required to form the target color corresponding to the target color point are determined according to a positional relationship between the target color point and each sub-region, each of the three primary colors is denoted as a first-type primary color, and each of the other primary colors is denoted as a second-type primary color.

In S3003, a driving component corresponding to the first-type primary color is determined according to a color coordinate of the target color point and a color coordinate of a primary color point of the first-type primary color, and a driving component corresponding to the second-type primary color is set to zero.

The sub-regions are delimited by three primary color points, and the first-type primary color includes three primary colors.

Specifically, the sub-region where the target color point is located can be determined according to the color coordinate of the target color point and the color coordinate of each primary color point, and three first-type primary colors required for synthesizing the target color can be determined according to the sub-region. According to a relationship equation between the color coordinate of the target color point and color coordinates of the three first-type primary colors, a unique solution of a driving component corresponding to the first-type primary color can be determined. Moreover, (M−3) driving components corresponding to other (M−3) primary colors are set to zero, and unique solutions of driving components corresponding to all the primary colors can be determined. This is conducive to simplifying a calculation process of determining the unique solutions. Moreover, more sub-regions can be delimited by three primary color points excluding an M-th primary color point, which is conducive to controlling a driving component corresponding to an M-th primary color to be zero when more target colors are synthesized to enhance an effect of removing blue light and further reduce the damage to the human eye.

In one embodiment of present disclosure, FIG. 7 is a schematic diagram of another chromatic diagram according to an embodiment of the present disclosure. Referring to FIG. 7, M=4, and E=2; the chromatic diagram includes a red (R) primary color point, a green (G) primary color point, a cyan (C) primary color point and a blue (B) primary color point, and wavelengths of an R primary color, a G primary color, a C primary color and a B primary color corresponding to the R primary color point, the G primary color point, the C primary color point and the B primary color point decrease in sequence; the sub-regions of the chromatic diagram include an RGC region delimited by the R primary color point, the G primary color point and the C primary color point and an RCB region delimited by the R primary color point, the C primary color point and the B primary color point.

For example, when the target color point of the target color is located in the RGC region, the R primary color, the G primary color and the C primary color may be first-type primary colors, the B primary color may be the second-type primary color, driving components corresponding to the R primary color, the G primary color and the C primary color have unique solutions, and a driving component corresponding to the B primary color is zero. When the target color point of the target color is located in the RCB region, the R primary color, the C primary color and the B primary color may be first-type primary colors, the G primary color may be the second-type primary color, driving components corresponding to the R primary color, the C primary color and the B primary color have unique solutions, and a driving component corresponding to the G primary color is zero. In this manner, when the target color point of the target color is located in the RGC region, the target color can be synthesized without using the B primary color, thereby removing blue light and reducing the damage of blue light to the human eye.

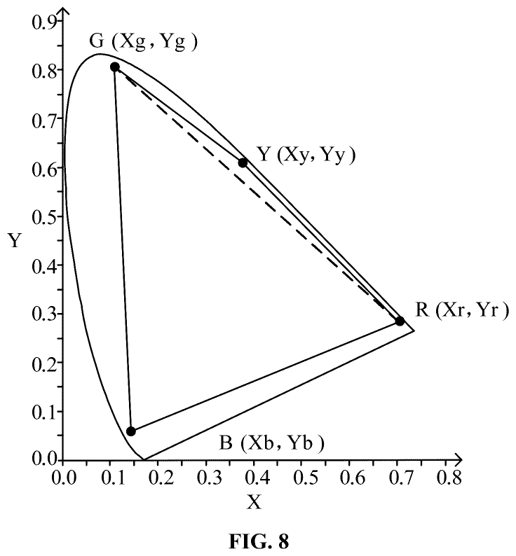

In other optional embodiments, when M=4, as shown in FIG. 8, the chromatic diagram may include a red (R) primary color point, a yellow (Y) primary color point, a green (G) primary color point and a blue (B) primary color point, wavelengths of an R primary color, a Y primary color, a G primary color and a B primary color corresponding to the R primary color point, the Y primary color point, the G primary color point and the B primary color point decrease in sequence, and in this case, E=2; the sub-regions of the chromatic diagram may include an RYG region delimited by the R primary color point, the Y primary color point and the G primary color point and an RGB region delimited by the R primary color point, the G primary color point and the B primary color point. When the target color point of the target color is located in the RYG region, the target color can be synthesized without using the B primary color, thereby removing blue light and reducing the damage of blue light to the human eye.

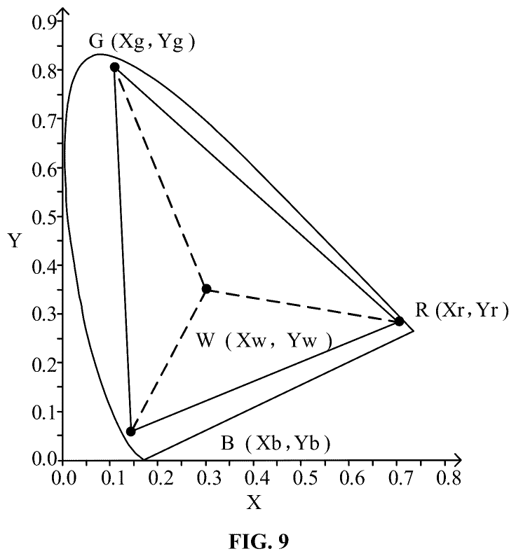

When M=4, as shown in FIG. 9, the chromatic diagram may further include a red (R) primary color point, a green (G) primary color point, a blue (B) primary color point and a white (W) primary color point, wavelengths of an R primary color, a G primary color and a B primary color corresponding to the R primary color point, the G primary color point and the B primary color point decrease in sequence, and a wavelength of a W primary color corresponding to the W primary color point may overlap wavelengths of multiple primary colors; the sub-regions of the chromatic diagram may include an RGW region delimited by the R primary color point, the G primary color point and the W primary color point, a GBW region delimited by the G primary color point, the B primary color point and the W primary color point and an RBW region delimited by the R primary color point, the B primary color point and the W primary color point. When the target color point of the target color is located in the RGW region, the target color can be synthesized without using the B primary color, thereby removing blue light and reducing the damage of blue light to the human eye.

In another embodiment of present disclosure, when M≥5, the number of sub-regions delimited by the three primary color points excluding the M-th primary color point is P, and 1≤P<E; 0.5≤P/E<1.

Specifically, when M≥5 and the sub-regions are delimited by three primary color points, the number E of sub-regions in the chromatic diagram is greater than or equal to 3. Reasonable delimitation can make at least half of all the sub-regions to be delimited by the three primary color points excluding the M-th primary color point. The number M of primary color points in the chromatic diagram is increased, and the number P of sub-regions delimited by the three primary color points excluding the M-th primary color point with the shortest wavelength may also be increased. Moreover, the M-th primary color with the shortest wavelength in a display is generally a blue primary color. This is conducive to further reducing blue light, thereby further reducing the damage of blue light to the human eye.

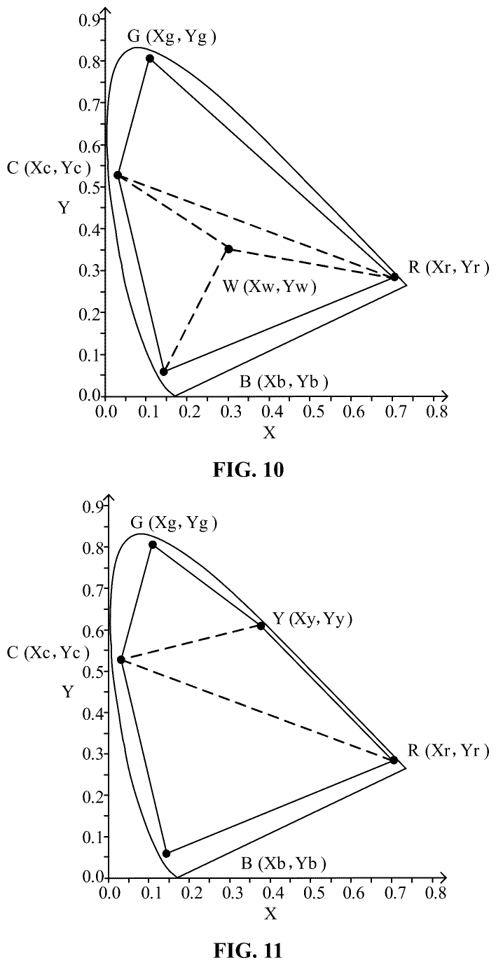

For example, FIG. 10 is a schematic diagram of another chromatic diagram according to an embodiment of the present disclosure. Referring to FIG. 10, M=5, the chromatic diagram includes a red (R) primary color point, a green (G) primary color point, a cyan (C) primary color point, a blue (B) primary color point and a white (W) primary color point, wavelengths of an R primary color, a G primary color, a C primary color and a B primary color corresponding to the R primary color point, the G primary color point, the C primary color point and the B primary color point decrease in sequence, and a wavelength of a W primary color corresponding to the W primary color point overlaps wavelengths of multiple primary colors; the sub-regions of the chromatic diagram include an RGC region delimited by the R primary color point, the G primary color point and the C primary color point, an RCW region delimited by the R primary color point, the C primary color point and the W primary color point, a CBW region delimited by the C primary color point, the B primary color point and the W primary color point and an RBW region delimited by the R primary color point, the B primary color point and the W primary color point. When the target color point of the target color is located in the RGC region or the RCW region, the target color can be synthesized without using the B primary color, thereby achieving the effect of removing blue light. Increasing the number P of sub-regions delimited by the three primary color points excluding the B primary color point is conducive to increasing a sum of areas of the sub-regions delimited by the three primary color points excluding the B primary color point, that is, the target color whose synthesis does not need to use the B primary color is increased, which is conducive to further reducing blue light.

Optionally, an area of the largest region enclosed by all the primary color points is S; a sum of areas of sub-regions delimited by multiple primary color points excluding the M-th primary color point is S′; 0.5≤S′/S<1.

The sub-region may be delimited by at least three primary color points and at most (M−1) primary color points. The sum of the areas of the sub-regions delimited by the multiple primary color points excluding the M-th primary color point is an area of regions enclosed by all primary color points except the M-th primary color point. When the M-th primary color point is a blue primary color, 0.5≤S′/S<1 can make a sum of areas of sub-regions delimited by multiple primary color points excluding a blue primary color point account for half or more of a total color gamut and can make the synthesis of at least half or more of target colors do not need to use the blue primary color with the shortest wavelength, which is conducive to reducing the use of blue light, thereby reducing the damage to the human eye.

For example, with continued reference to FIG. 10, M=5, the chromatic diagram includes an R primary color point, a G primary color point, a C primary color point, a B primary color point and a W primary color point, an RGCB region is the largest region delimited by the R primary color point, the G primary color point, the C primary color point, the B primary color point and the W primary color point, S is an area of the RGCB region, S′ is an area of an RGCW region delimited by the R primary color point, the G primary color point, the C primary color point and the W primary color point, and any target color in the RGCW region can be synthesized by other primary colors excluding a B primary color. Specific positions of the R primary color point, the G primary color point, the C primary color point, the B primary color point and the W primary color point are not limited in the embodiment of the present disclosure, especially the specific positions of the C primary color point and the W primary color point that are newly added in addition to the R primary color point, the G primary color point and the B primary color point. The specific positions of the C primary color point and the W primary color point can be set and adjusted to achieve 0.5≤S′/S<1.

Optionally, a wavelength of the first primary color is greater than at least some wavelengths of the second primary color to the M-th primary color, and at least one of the sub-regions is delimited by multiple primary color points excluding a first primary color point corresponding to the first primary color.

The sub-region may be delimited by at least three primary color points and at most (M−1) primary color points.

For example, with continued reference to FIG. 10, M=5, the chromatic diagram includes an R primary color point, a G primary color point, a C primary color point, a B primary color point and a W primary color point, wavelengths of an R primary color, a G primary color, a C primary color and a B primary color corresponding to the R primary color point, the G primary color point, the C primary color point and the B primary color point decrease in sequence, and a wavelength of a W primary color corresponding to the W primary color point overlaps wavelengths of multiple primary colors; the first primary color is the R primary color. The sub-regions include a CBW region delimited by multiple primary color points excluding the first primary color point corresponding to the first primary color. When the target color point of the target color is located in the CBW region, the target color can be synthesized without using the R primary color so that the use of an R primary color pixel with relatively low luminescence efficiency, which is conducive to reducing the power consumption of the display.

In one embodiment of present disclosure, a first sub-region is a sub-region delimited by the multiple primary color points excluding the first primary color point, and the multiple primary color points delimiting the first sub-region do not include the M-th primary color point; and/or a second sub-region is a sub-region delimited by multiple primary color points excluding the M-th primary color point, and the multiple primary color points delimiting the second sub-region include the first primary color point.

Specifically, when the target color point of the target color is located in the first sub-region, the target color can be synthesized by multiple primary colors excluding the first primary color, resulting in a relatively small average wavelength of the primary colors for synthesizing the target color, a relatively high average frequency of light and certain damage to the human eye. However, the synthesis of the target color does not use the M-th primary color with a relatively short wavelength so that the M-th primary color can be prevented from further lowering the average wavelength and increasing the average frequency of light, which is conducive to reducing the damage of light to the human eye. When the target color point of the target color is located in the second sub-region, the target color is synthesized by multiple primary colors including the M-th primary color, resulting in a relatively small average wavelength of the primary colors for synthesizing the target color, a relatively high average frequency of light and certain damage to the human eye. However, the synthesis of the target color also uses the first primary color with a relatively long wavelength. The first primary color can increase the average wavelength and reduce the average frequency of light, thereby reducing the damage of light to the human eye.

For example, FIG. 11 is a schematic diagram of another chromatic diagram according to an embodiment of the present disclosure. Referring to FIG. 11, M=5, E=3, the chromatic diagram includes a red (R) primary color point, a yellow (Y) primary color point, a green (G) primary color point, a cyan (C) primary color point and a blue (B) primary color point, and wavelengths of an R primary color, a Y primary color, a G primary color, a C primary color and a B primary color corresponding to the R primary color point, the Y primary color point, the G primary color point, the C primary color point and the B primary color point decrease in sequence; the sub-regions of the chromatic diagram include a YGC region delimited by the Y primary color point, the G primary color point and the C primary color point, an RYC region delimited by the R primary color point, the Y primary color point and the C primary color point and an RCB region delimited by the R primary color point, the C primary color point and the B primary color point. The YGC region is the first sub-region, and the primary color points delimiting the YGC region include neither the R primary color point nor the B primary color point. The RCB region is the second sub-region, and the primary color points delimiting the RCB region include the B primary color point and the R primary color point. In this manner, when the target color point of the target color is located in the YGC region, the target color can be synthesized by the R primary color, the G primary color and the C primary color excluding the R primary color and the B primary color; when the target color point of the target color is located in the RCB region, the target color can be synthesized by the R primary color, the C primary color and the B primary color including the B primary color and the R primary color, which is conducive to increasing an average wavelength (or reducing an average frequency) of the primary colors and conducive to reducing the damage to the human eye.

In another embodiment of present disclosure, when M≥5 and E≥4, the number of sub-regions delimited by three primary color points excluding the first primary color point is Q, and 1≤Q<E; 0.5≤Q/E<1.

Specifically, when M≥5 and E≥4, by reasonable delimitation, it is possible to ensure that at least half of all the sub-regions are delimited by multiple primary color points excluding the first primary color point. The number M of primary color points and the number E of sub-regions in the chromatic diagram are increased, and the number Q of sub-regions delimited by multiple primary color points excluding the first primary color point with the longest wavelength may also be increased. Moreover, the first primary color with the longest wavelength in the display is generally a red primary color. The luminescence efficiency of a red light-emitting device is not high, which is conducive to low power consumption of the display.

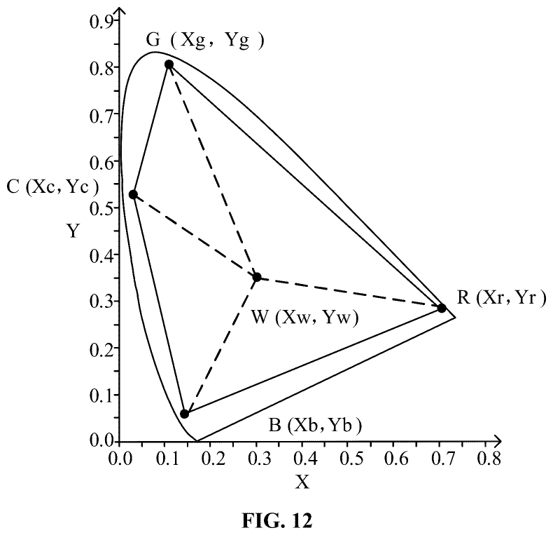

For example, FIG. 12 is a schematic diagram of another chromatic diagram according to an embodiment of the present disclosure. Referring to FIG. 12, M=5, E=4, the chromatic diagram includes a red (R) primary color point, a green (G) primary color point, a cyan (C) primary color point, a blue (B) primary color point and a white (W) primary color point, wavelengths of an R primary color, a G primary color, a C primary color and a B primary color corresponding to the R primary color point, the G primary color point, the C primary color point and the B primary color point decrease in sequence, and a wavelength of a W primary color corresponding to the W primary color point overlaps wavelengths of multiple primary colors. The sub-regions of the chromatic diagram include an RGW region delimited by the R primary color point, the G primary color point and the W primary color point, a GCW region delimited by the G primary color point, the C primary color point and the W primary color point, a CBW region delimited by the C primary color point, the B primary color point and the W primary color point and an RBW region delimited by the R primary color point, the B primary color point and the W primary color point. When the target color point of the target color is located in the GCW region or the CBW region, the target color can be synthesized without using the R primary color, which is conducive to low power consumption.

Increasing the number Q of sub-regions delimited by multiple primary color points excluding the R primary color point is conducive to increasing a sum of areas of the sub-regions delimited by the multiple primary color points excluding the B primary color point, that is, the target color whose synthesis does not need to use the R primary color is increased, which is conducive to further reducing power consumption. In addition, setting the W primary color point can increase a W primary color pixel and increase an area of the sub-regions delimited by multiple primary color points including the W primary color point so that target colors in at least some regions can be synthesized by the W primary color and other primary colors, which is conducive to improving a display effect and reducing color cast, especially improving a display effect of a white image of the display and reducing the color cast of the white image at close range.

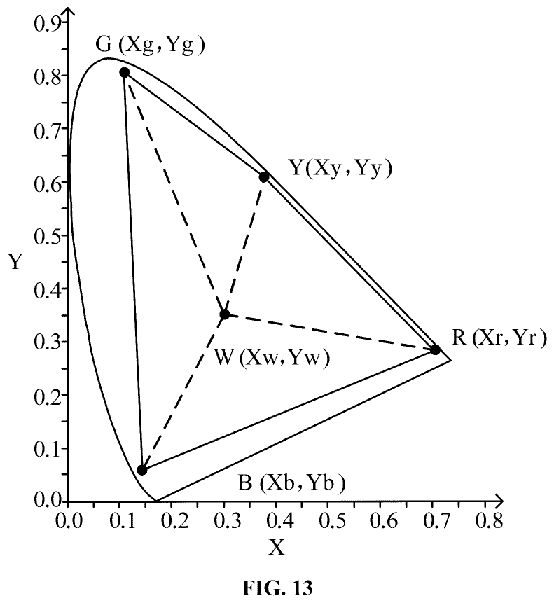

In other embodiments, as shown in FIG. 13, when M=5 and E=4, the chromatic diagram may further include a red (R) primary color point, a yellow (Y) primary color point, a green (G) primary color point, a blue (B) primary color point and a white (W) primary color point, wavelengths of an R primary color, a Y primary color, a G primary color and a B primary color corresponding to the R primary color point, the Y primary color point, the G primary color point and the B primary color point decrease in sequence, and a wavelength of a W primary color corresponding to the W primary color point overlaps wavelengths of multiple primary colors. The sub-regions of the chromatic diagram include an RYW region delimited by the R primary color point, the Y primary color point and the W primary color point, a GBW region delimited by the G primary color point, the B primary color point and the W primary color point and an RBW region delimited by the R primary color point, the B primary color point and the W primary color point. When the target color point of the target color is located in the YGW region or the GBW region, the target color can be synthesized without using the R primary color, which is conducive to low power consumption.

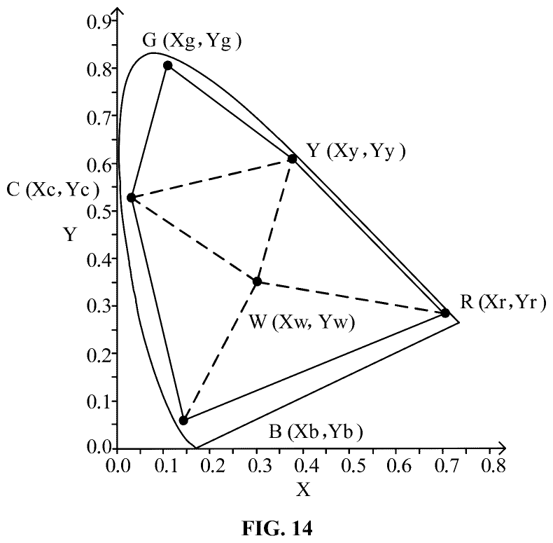

For example, FIG. 14 is a schematic diagram of another chromatic diagram according to an embodiment of the present disclosure. Referring to FIG. 14, M=6, E=5, the chromatic diagram includes a red (R) primary color point, a yellow (Y) primary color point, a green (G) primary color point, a cyan (C) primary color point, a blue (B) primary color point and a white (W) primary color point, wavelengths of an R primary color, a Y primary color, a G primary color, a C primary color and a B primary color corresponding to the R primary color point, the Y primary color point, the G primary color point, the C primary color point and the B primary color point decrease in sequence, and a wavelength of a W primary color corresponding to the W primary color point overlaps wavelengths of multiple primary colors. The sub-regions of the chromatic diagram include a YGC region delimited by the Y primary color point, the G primary color point and the C primary color point, an RYW region delimited by the R primary color point, the Y primary color point and the W primary color point, a YCW region delimited by the Y primary color point, the C primary color point and the W primary color point, a CBW region delimited by the C primary color point, the B primary color point and the W primary color point and an RBW region delimited by the R primary color point, the B primary color point and the W primary color point. When the target color point of the target color is located in the YGC region, the YCW region or the CBW region, the target color can be synthesized without using the R primary color, which is conducive to low power consumption. When the target color point of the target color is located in the YGC region, the YCW region or the RYW region, the target color can be synthesized without using the B primary color, which is conducive to reducing the damage to the human eye.

In the embodiment of FIG. 14, the sum of areas of sub-regions delimited by the multiple primary color points excluding the R primary color point and the sum of areas of sub-regions delimited by the multiple primary color points excluding the B primary color point are added, and the sum of areas of sub-regions delimited by the multiple primary color points excluding the R primary color point and the B primary color point is also added, thereby further optimizing the image conversion method, determining a unique solution and taking into account both low power consumption and blue light removal.

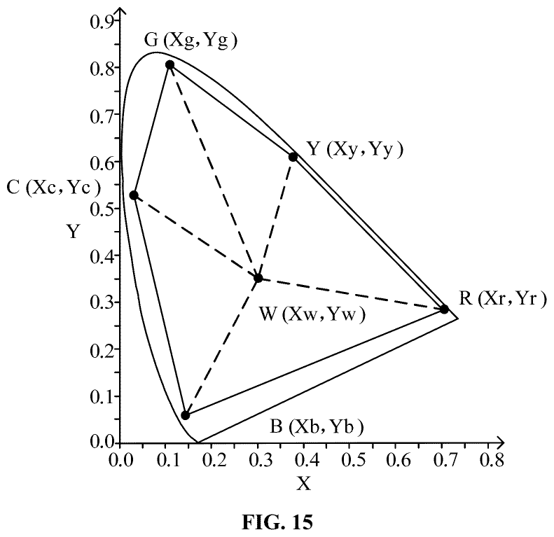

In other embodiments, as shown in FIG. 15, when M=6 and E=5, the sub-regions of the chromatic diagram may further include an RYW region delimited by the R primary color point, the Y primary color point and the W primary color point, a YGW region delimited by the Y primary color point, the G primary color point and the W primary color point, a GCW region delimited by the G primary color point, the C primary color point and the W primary color point, a CBW region delimited by the C primary color point, the B primary color point and the W primary color point and an RBW region delimited by the R primary color point, the B primary color point and the W primary color point. When the target color point of the target color is located in any sub-region, the target color can be synthesized by multiple primary colors including the W primary color, which is conducive to increasing white light, improving the display effect and reducing the color cast.

In another embodiment of present disclosure, an area of the largest region enclosed by all the primary color points is S; a sum of areas of the sub-regions delimited by the multiple primary color points excluding the first primary color point is S″; 0.5≤S″/S<1.

The sub-region may be delimited by at least three primary color points and at most (M−1) primary color points. The sum of the areas of the sub-regions delimited by the multiple primary color points excluding the first primary color point is an area of regions enclosed by all primary color points except the first primary color point. When the first primary color point is a red primary color, 0.5≤S″/S<1 can make a sum of areas of sub-regions delimited by multiple primary color points excluding a red primary color point account for half or more of a total color gamut and can make the synthesis of at least half or more of target colors do not use the red primary color with relatively low luminescence efficiency, which is conducive to reducing the use of red light, thereby reducing the power consumption.

For example, referring to FIGS. 14 and 15, M=6, the chromatic diagram includes an R primary color point, a Y primary color point, a G primary color point, a C primary color point, a B primary color point and a W primary color point, an RYGCB region is the largest region delimited by the R primary color point, the Y primary color point, the G primary color point, the C primary color point, the B primary color point and the W primary color point, S is an area of the RYGCB region, S″ is an area of a YGCBW region delimited by the Y primary color point, the G primary color point, the C primary color point, the B primary color point and the W primary color point, and any target color in the YGCBW region can be synthesized by other primary colors excluding an R primary color. Specific positions of the R primary color point, the G primary color point, the C primary color point, the B primary color point and the W primary color point are not limited in the embodiment of the present disclosure, especially the specific positions of the Y primary color point, the C primary color point and the W primary color point that are newly added in addition to the R primary color point, the G primary color point and the B primary color point. The specific positions of the Y primary color point, the C primary color point and the W primary color point can be set and adjusted to achieve 0.5≤S″/S<1.

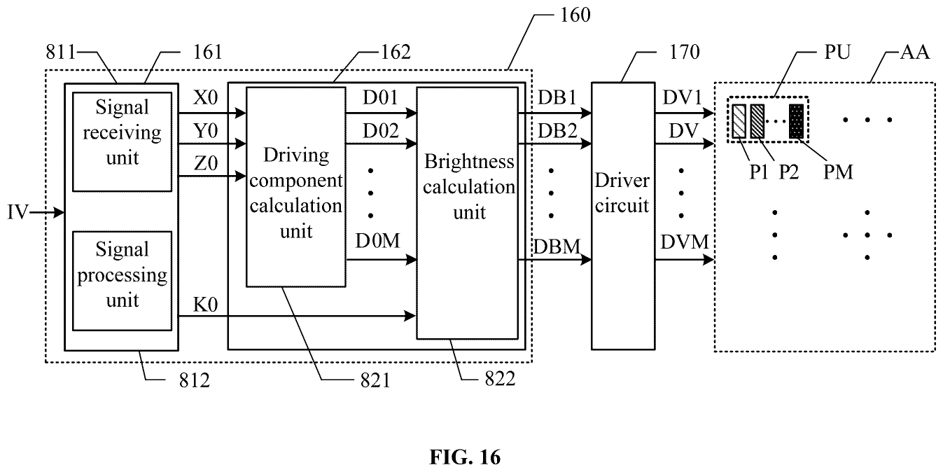

Based on the same inventive concept, embodiments of the present disclosure further provide an image conversion apparatus. The image conversion apparatus can be used for performing the image conversion method provided in any embodiment of the present disclosure. FIG. 16 is a structure diagram of an image conversion apparatus according to an embodiment of the present disclosure. Referring to FIG. 16, the image conversion apparatus includes a receiving module 161 and an image conversion module 162.

The receiving module 161 is configured to acquire a target color and determine a target color point of the target color in a chromatic diagram, where the chromatic diagram includes M primary color points, the M primary color points correspond to M primary colors, M is an integer, and M≥4. The chromatic diagram further includes E sub-regions delimited by multiple primary color points, E is an integer, and E≥2; among at least part of the sub-regions, two sub-regions do not overlap with each other.

The image conversion module 162 is configured to perform the following operations: M driving components (D01, D02, . . . and D0M) corresponding to the M primary colors and a relationship equation between a color coordinate (X0, Y0, Z0) of the target color point and a color coordinate (Xi, Yi, Zi) of each primary color point are defined: (X0, Y0, Z0)=D01*(X1, Y1, Z1)+D02*(X2, Y2, Z2)+ . . . +D0M*(XM, YM, ZM), where 1≤i≤M, and i is an integer; a first value range of a first driving component D01 is determined according to the relationship equation, the first driving component D01 is set to a maximum value within the first value range, and values of remaining (M−1) driving components; and/or an M-th value range of an M-th driving component D0M is determined according to the relationship equation, the M-th driving component D0M is set to a minimum value within the M-th value range, and values of remaining (M−1) driving components are determined; and/or primary colors required to form the target color corresponding to the target color point are determined according to a positional relationship between the target color point and each sub-region, each of the primary colors is denoted as a first-type primary color, and each of the other primary colors is denoted as a second-type primary color; a driving component corresponding to the first-type primary color is determined according to a color coordinate of the target color point and a color coordinate of a primary color point of the first-type primary color, and a driving component corresponding to the second-type primary color is set to zero.

The M primary colors include a first primary color, a second primary color, . . . and an M-th primary color, a wavelength of the first primary color is greater than at least some wavelengths of the second primary color to the M-th primary color, and a wavelength of the M-th primary color is less than at least some wavelengths of the first primary color to an (M−1)-th primary color.

For example, referring to FIG. 16, the receiving module 61 may include a signal receiving unit 811 and a signal processing unit 812, and the image conversion module 162 may include a driving component calculation unit 821 and a brightness calculation unit 822.

The signal receiving unit 811 is configured to receive an input signal IV of an image to be displayed, and the image to be displayed includes a target color to be displayed. The signal processing unit 812 is configured to convert the input signal IV into a corresponding RGB brightness input value, and determine a target color corresponding to the input signal and a color coordinate (X0, Y0, Z0) of the target color according to the RGB brightness input value. The signal processing unit 812 may also convert brightness information of the target color in the input signal IV into a brightness parameter K0.

The driving component calculation unit 821 is configured to determine unique solutions of driving components (D01, D02, . . . and D0M) corresponding to the primary colors according to the received color coordinate (X0, Y0, Z0) of the target color and the received relationship equation between the color coordinate of the target color and the color coordinate of each primary color. The brightness calculation unit 822 is configured to determine brightness output values (DB1, DB2, . . . and DBM) of the primary colors according to the driving components (D01, D02, . . . and D0M) corresponding to the primary colors and the brightness parameter K0.

A driver circuit 170 in a display can determine drive voltages (DV1, DV2, . . . and DVM) of primary color pixels (P1, P2, . . . and PM) according to the brightness output values (DB1, DB2, . . . and DBM) of the primary colors and output the drive voltages corresponding to the brightness of the primary colors to the primary color pixels in a display region AA so that multiple primary color pixels display the target color. In an embodiment, the display can display multiple target colors at multiple positions simultaneously and can display multiple target colors row by row, using persistence of vision in the human eye to display a complete image in the human eye.

It is to be noted that in FIG. 16, only one structure diagram of the image conversion apparatus 160 is illustrated exemplarily, and for ease of understanding, a portion of the structure in the display is also illustrated exemplarily. However, the structure of the image conversion apparatus 160 and the structure of the display are not limited to thereto. In one embodiment of present disclosure, the image conversion apparatus 160 may be disposed in the driver circuit 170. In another embodiment of present disclosure, at least a portion of the structure of the driver circuit 170 may be disposed in the display region AA.

The image conversion apparatus provided in the embodiment of the present disclosure can perform the image conversion method provided in any embodiment of the present disclosure and has the function modules and beneficial effects of the image conversion method. For contents not described in detail in the embodiment of the image conversion apparatus, reference may be made to the above description of the image conversion method, which is not repeated here. Similarly, the image conversion method in the embodiment of the present disclosure also has the technical features and beneficial effects corresponding to the image conversion apparatus. For contents not described in detail in the embodiment of the image conversion method, reference may be made to the above description of the image conversion apparatus, which is not repeated here.

Based on the same inventive concept, embodiments of the present disclosure further provide a display device. The display device may include a display panel or, in other embodiments, a display apparatus. The display device may be any electronic product with a display function, including but not limited to the following categories: a television, a notebook computer, a desktop display, a tablet computer, a digital camera, a smart bracelet, a pair of smart glasses, an in-vehicle display, a medical equipment, an industrial control equipment and a touch interactive terminal, which is not specially limited in the present disclosure. In one embodiment of present disclosure, the display device may include the image conversion apparatus provided in any embodiment of the present disclosure.

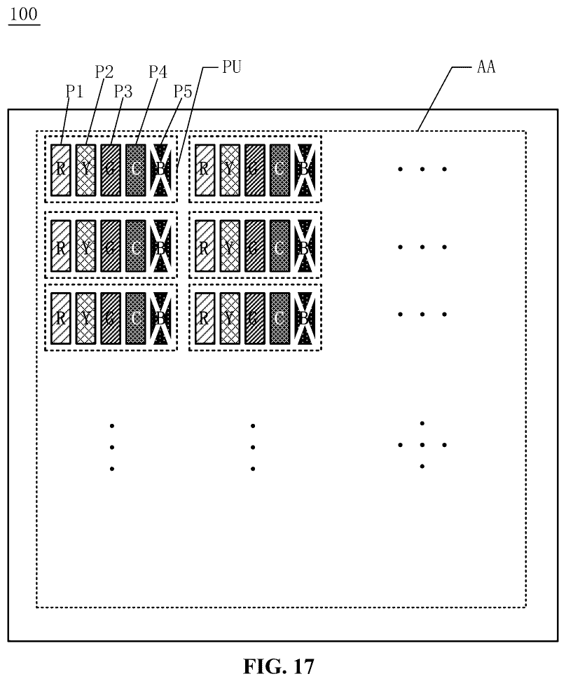

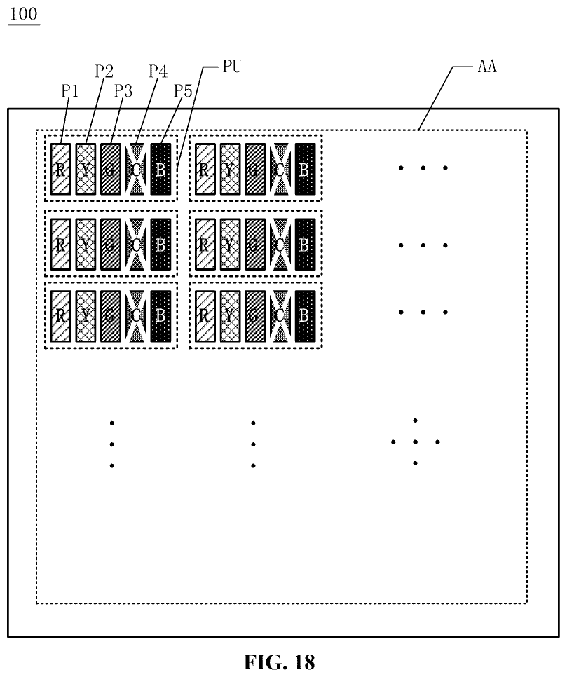

FIG. 17 is a top view of a display device according to an embodiment of the present disclosure, and FIG. 18 is a top view of another display device according to an embodiment of the present disclosure. Referring to FIGS. 17 and 18, the display device 100 provided in the embodiment of the present disclosure includes multiple pixel units PU, the pixel unit PU includes M types of primary color pixels (P1, P2, . . . and PM), Mis an integer, and M≥4. A display mode of the display device 100 includes a first display mode; in the first display mode and the same pixel unit PU, N types of primary color pixels are in a bright state, (M−N) types of primary color pixels are in a black state, N is an integer, and 3≤N<M. In the first display mode, at least some light wavelengths of the (M−N) types of primary color pixels in the black state are at least less than at least some light wavelengths of (N−1) types of primary color pixels in the bright state.

The primary color pixel can emit light of a primary color. In one embodiment of present disclosure, the primary color pixel may include a pixel driving circuit and a light-emitting device. In another embodiment of present disclosure, the primary color pixel may also include a portion of backlight module, a portion of liquid crystal layer and a primary color light-filtering layer. In another embodiment of present disclosure, the primary color pixel may also include a pixel driving circuit, a white light-emitting device and a light-filtering film located on a surface of the white light-emitting device. It is to be noted that the structure diagram of the primary color pixels (P1, P2, . . . and PM) in the figure may indicate a position where the pixel driving circuit is disposed or positions where the light-emitting device, the light-filtering layer and the light-filtering film are disposed, which are not limited in the embodiment of the present disclosure.

The M primary colors (P1, P2, . . . and PM) correspond to M primary colors. The M primary colors may include single-color primary colors, for example, primary colors such as red (R), yellow (Y), green (G), cyan (C) and blue (B), and the M primary colors may further include mixed-color primary colors, for example, primary colors such as white (W). A light wavelength of the single-color primary color pixel may be a certain specific wavelength value or a certain wavelength range, and light wavelengths of different single-color primary color pixels at least partially do not overlap with each other. A light wavelength of the mixed-color primary color pixel may be multiple specific wavelength values, or may also be one or more wavelength ranges. The light wavelength of the mixed-color primary color pixel may overlap wavelengths of other single-color primary color pixels.

In one embodiment of present disclosure, the light wavelength of the primary color pixel may be a peak wavelength or crest wavelength of a luminescent spectrum of the primary color pixel. A luminescent spectrum of the single-color primary color pixel may include at least one peak wavelength and/or at least one crest wavelength, and the mixed-color primary color pixel may include multiple peak wavelengths or multiple crest wavelengths. In another embodiment of present disclosure, the light wavelength of the primary color pixel may further be a wavelength range in the luminescent spectrum of the primary color pixel that is greater than a preset brightness threshold or a wavelength range that is greater than a preset percentage of the maximum brightness amplitude. In another embodiment of present disclosure, light wavelengths of different single-color primary colors do not overlap with each other.

Specifically, at least some light wavelengths of the (M−N) types of primary color pixels in the black state may be less than at least some light wavelengths of the N types of primary color pixels in the bright state, and 3≤N<M. That is, a light wavelength of at least one primary color pixel in the black state is less than at least some light wavelengths of all the primary color pixels in the bright state. In other words, in the first display mode and the same pixel unit PU, at least one type of primary color pixel is in the black state, and the primary color pixel in the black state at least includes a primary color pixel with the shortest light wavelength among all the primary color pixels.

And/or, at least some light wavelengths of the (M−N) types of primary color pixels in the black state may be less than at least some light wavelengths of the (N−1) types of primary color pixels in the bright state, and 3≤N<M. That is, a light wavelength of at least one primary color pixel in the black state is greater than a light wavelength of one type of primary color pixel in the bright state and less than at least some light wavelengths of the (N−1) types of primary color pixels in the bright state. In other words, in the first display mode and the same pixel unit PU, the primary color pixel with the shortest light wavelength among all the primary color pixels is in the bright state, and the primary color pixels in the black state at least include a primary color pixel with the second shortest light wavelength among all the primary color pixels.

As can be seen from the above contents, in the first display mode and the same pixel unit PU, the primary color pixel with the shortest light wavelength among all the primary color pixels does not emit light; alternatively, the primary color pixel with the shortest light wavelength among all the primary color pixels emits light, and the primary color pixel with the second shortest light wavelength among all the primary color pixels does not emit light.

The following conditions are used as an example: M=5, N=4, the pixel unit PU of the display device 100 includes a red (R) pixel, a yellow (Y) pixel, a green (G) pixel, a cyan (C) pixel and a blue (B) pixel and light wavelengths of the R pixel, the Y pixel, the G pixel, the C pixel and the B pixel decrease in sequence. With continued reference to FIGS. 17 and 18, the pixel unit PU includes an R pixel, a Y pixel, a G pixel, a C pixel and a B pixel; in the first display mode, the B pixel does not emit light, and the R pixel, the Y pixel, the G pixel and the C pixel emit light; alternatively, the pixel unit PU includes an R pixel, a Y pixel, a G pixel, a C pixel and a B pixel, and in the first display mode, the C pixel does not emit light, and the R pixel, the Y pixel, the G pixel and the B pixel emit light.

In other embodiments, when M=4, N=3, the pixel unit of the display device may include an R pixel, a Y pixel, a G pixel and a B pixel, in the first display mode, the B pixel does not emit light, and the R pixel, the Y pixel and the G pixel emit light, alternatively, the G pixel does not emit light, and the R pixel, the Y pixel and the B pixel emit light; when M=4, N=3, the pixel unit of the display device may also include an R pixel, a G pixel, a C pixel and a B pixel, in the first display mode, the B pixel does not emit light, and the R pixel, the G pixel and the C pixel emit light, alternatively, the C pixel does not emit light, and the R pixel, the G pixel and the B pixel emit light.

When M=5, N=3 is also possible. The condition that the pixel unit of the display device includes an R pixel, a Y pixel, a G pixel, a C pixel and a B pixel continues to be used as an example. In the first display mode, the R pixel and the B pixel may not emit light, the Y pixel and the B pixel may not emit light, the G pixel and the B pixel may not emit light, the C pixel and the B pixel may not emit light, the R pixel and the C pixel may not emit light, the Y pixel and the C pixel may not emit light, or the G pixel and the C pixel may not emit light, and other primary color pixels emit light. When M=5, the pixel unit of the display device may also include an R pixel, a G pixel, a C pixel, a B pixel and a white (W) pixel, a light wavelength of the W pixel may overlap light wavelengths of multiple primary color pixels, and N=3 or 4. In the first display mode, the B pixel may not emit light, the C pixel may not emit light, the R pixel and the B pixel may not emit light, the Y pixel and the B pixel may not emit light, the G pixel and the B pixel may not emit light, the C pixel and the B pixel may not emit light, the R pixel and the C pixel may not emit light, or the G pixel and the C pixel may not emit light, and other primary color pixels emit light.

In addition, M=6 and N=3, 4 or 5 are also possible. The pixel unit of the display device may include an R pixel, a Y pixel, a G pixel, a C pixel, a B pixel and a W pixel. In the first display mode, at least the B pixel is controlled not to emit light; alternatively, the B pixel emits light, and the C pixel does not emit light. The examples are not listed one by one in the present disclosure.

In the preceding embodiment, when N=3, in the first display mode and the same pixel unit, only three types of primary color pixels emit light, and other primary color pixels do not emit light. The three types of primary color pixels are used for displaying the target color. Driving components of primary colors corresponding to the three types of primary color pixels that emit light have unique solutions, and driving components of primary colors corresponding to other primary color pixels that do not emit light are all zero so that unique solutions of the driving components of all the primary colors can be determined. Further, the drive voltages of the primary color pixels are determined according to the driving components of the primary colors so that the primary color pixels present the required brightness.

When N>3, in the first display mode and the same pixel unit, N types of primary color pixels emit light, and other primary color pixels do not emit light. The N types of primary color pixels are used for displaying the target color. Driving components of primary colors corresponding to the N types of primary color pixels that emit light have multiple solutions, and a unique solution of the driving components of the primary colors corresponding to the N types of primary color pixels that emit light can be determined through an existing image conversion method or the image conversion method provided in any embodiment of the present disclosure. Driving components of primary colors corresponding to other primary color pixels that do not emit light are all zero. In this manner, the unique solutions of the driving components of all the primary colors can be determined. Further, the drive voltages of the primary color pixels are determined according to the driving components of the primary colors. How to determine the unique solution of the driving components of the primary colors corresponding to the N types of primary color pixels that emit light is not limited in the embodiment of the present disclosure. Preferably, among the N types of primary color pixels that emit light, the brightness of a primary color pixel with a relatively large light wavelength is increased as much as possible, and/or the brightness of a primary color pixel with a relatively short light wavelength is decreased as much as possible so that the primary color pixels present the required brightness.

In the embodiment of the present disclosure, four or more primary color pixels are set in the pixel unit, which is conducive to increasing a color gamut of the display device and displaying more colors, thereby providing rich color performance and presenting more vibrant and vivid colors. Further, the first display mode is set, and in the first display mode, at least one primary color pixel is in the black state so that the types of primary color pixels in the bright state are reduced, which is conducive to reducing linear combinations of M(M≥3) types of primary color pixels and simplifying the calculation of the brightness of the primary color pixels. In addition, in the first display mode, at least some light wavelengths of the (M−N) types of primary color pixels in the black state are at least less than at least some light wavelengths of (N−1) types of primary color pixels in the bright state so that the primary color pixel with the shortest light wavelength is in the black state, or when the primary color pixel with the shortest light wavelength needs to be in the bright state inevitably, at least the primary color pixel with the second shortest light wavelength is in the black state, which is conducive to reducing short-wavelength light and increasing an average wavelength, thereby reducing the damage of high-frequency (short-wavelength) light to the human eye.

Optionally, the first display mode includes a first sub-mode. In the first sub-mode, at least some light wavelengths of the (M−N) types of primary color pixels in the black state are less than at least some light wavelengths of the N types of primary color pixels in the bright state; the pixel unit includes a first primary color pixel, a second primary color pixel, . . . and an M-th primary color pixel, and a light wavelength of the M-th primary color pixel is less than at least some light wavelengths of the first primary color pixel to an (M−1)-th primary color pixel; in the first sub-mode, the M-th primary color pixel is in the black state.

Among all the primary color pixels, the M-th primary color pixel is a single-color primary color pixel with the shortest light wavelength, and the light wavelength of the M-th primary color pixel may be less than at least some light wavelengths of a mixed-color primary color pixel.

Specifically, in the first sub-mode, the (M−N) types of primary color pixels in the black state at least include the M-th primary color pixel with the shortest light wavelength, that is, in the first sub-mode, the display device can display any target color synthesized by multiple primary colors excluding the M-th primary color corresponding to the M-th primary color pixel.

It is to be noted that in the embodiment of the present disclosure, due to the grayscale limitation of the primary color pixels, the brightness of the primary color pixels is generally discretely distributed rather than continuously distributed. Therefore, when the brightness of the primary color pixels is discrete, all target colors presented by multiple primary color pixels are also discretely distributed. Mentioned in the embodiment of the present disclosure, the expression that the display device can display any target color in the region means that the display device can display any one of all the discretely distributed target colors in the region and does not mean that the display device can display a color at any position in the region.

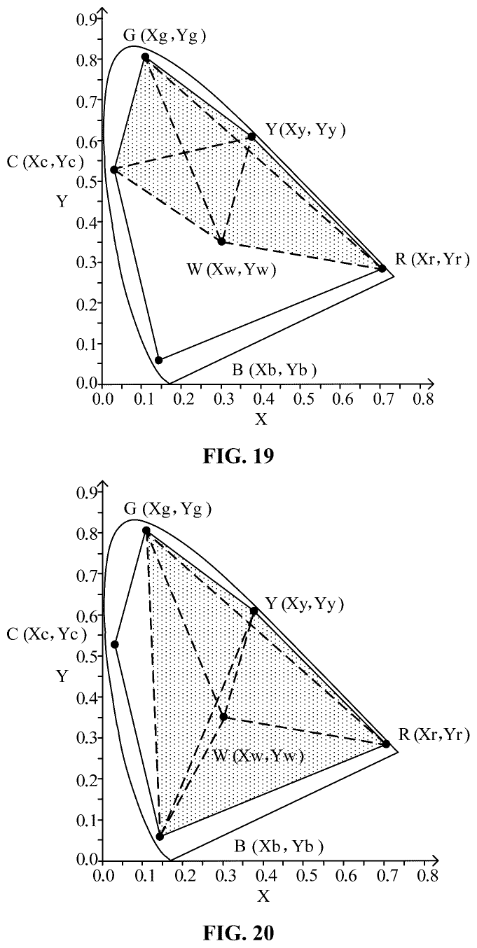

For example, M=6, the pixel unit includes a red (R) pixel, a yellow (Y) pixel, a green (G) pixel, a cyan (C) pixel, a blue (B) pixel and a white (W) pixel, light wavelengths of the R pixel, the Y pixel, the G pixel, the C pixel and the B pixel decrease in sequence, and a light wavelength of the W pixel may overlap light wavelengths of multiple primary color pixels. The R pixel, the Y pixel, the G pixel, the C pixel, the B pixel and the W pixel correspond to the R primary color, the Y primary color, the G primary color, the C primary color, the B primary color and the W primary color, respectively, and also correspond to the R primary color point, the Y primary color point, the G primary color point, the C primary color point, the B primary color point and the W primary color point in the chromatic diagram, respectively. As shown in FIG. 19, the M-th primary color pixel is the B pixel; in the first sub-mode, the display device can display any target color in a region (such as the filled region shown in FIG. 19) enclosed by multiple primary color points excluding the B primary color point, and the region may be any region located in an RYGCW region enclosed by the R primary color point, the Y primary color point, the G primary color point, the C primary color point and the W primary color point. In this manner, the display of some target colors does not need the light emission of the B pixel, thereby reducing blue light with the shortest wavelength and reducing the damage of the display device to the human eye.

On the basis of the preceding embodiment, a light wavelength of the first primary color pixel is greater than at least some light wavelengths of the second primary color pixel to the M-th primary color pixel; in the first sub-mode, the first primary color pixel is in the black state.

Among all the primary color pixels, the first primary color pixel is a single-color primary color pixel with the longest light wavelength, and the light wavelength of the first primary color pixel may be greater than at least some light wavelengths of a mixed-color primary color pixel. Specifically, in the first sub-mode, the (M−N) types of primary color pixels in the black state at least include the M-th primary color pixel with the shortest light wavelength and the first primary color pixel with the longest light wavelength are included. Generally, the primary color with a relatively short wavelength corresponds to a primary color pixel with relatively high luminescence efficiency and causes more damage to the human eye, and the primary color with a relatively long wavelength corresponds to a primary color pixel with relatively low luminescence efficiency and causes less damage to the human eye.

For example, M=6, and the pixel unit includes the R pixel, the Y pixel, the G pixel, the C pixel and the B pixel. The M-th primary color pixel is the B pixel, and the first pixel is the R pixel. In the first sub-mode, the display device may display any target color in a region enclosed by multiple primary color points excluding the B primary color point and the R primary color point, and the region may be any region located in the an RYGCW region enclosed by the Y primary color point, the G primary color point, the C primary color point and the W primary color point. In this manner, the display of some target colors needs neither the light emission of the B pixel nor the light emission of the R pixel so that both the damage of high-frequency (short-wavelength) light to the human eye and the energy loss caused by long-wavelength light can be reduced to take into account both low power consumption and blue light removal.

Optionally, the first display mode includes a second sub-mode. In the second sub-mode, at least some light wavelengths of the (M−N) types of primary color pixels in the black state are less than at least some light wavelengths of the (N−1) types of primary color pixels in the bright state; the primary color pixel includes a first primary color pixel, . . . , an (M−1)-th primary color pixel and an M-th primary color pixel, a wavelength of the M-th primary color pixel is less than at least some light wavelengths of the first primary color pixel to the (M−1)-th primary color pixel, and a wavelength of the (M−1)-th primary color pixel is less than at least some light wavelengths of the first primary color pixel to an (M−2)-th primary color pixel; in the second sub-mode, the M-th primary color pixel is in the bright state, and the (M−1)-th primary color pixel is in the black state.

Among all the primary color pixels, the M-th primary color pixel is a single-color primary color pixel with the shortest light wavelength, the (M−1)-th primary color pixel is a single-color primary color pixel with the second shortest light wavelength, and each of the light wavelength of the M-th primary color pixel and the light wavelength of the (M−1)-th primary color pixel may be less than at least some light wavelengths of a mixed-color primary color pixel.

Specifically, in the second sub-mode, the N types of primary color pixels in the bright state at least include the M-th primary color pixel with the shortest light wavelength, and the (M−N) types of primary color pixels in the black state at least include the (M−1)-th primary color pixel with the second shortest light wavelength. That is, in the second sub-mode, the display device any target color synthesized by multiple primary colors including the M-th primary color corresponding to the M-th primary color pixel and excluding the (M−1)-th primary color corresponding to the (M−1)-th primary color pixel.

For example, the pixel unit includes a red (R) pixel, a yellow (Y) pixel, a green (G) pixel, a cyan (C) pixel, a blue (B) pixel and a white (W) pixel, light wavelengths of the R pixel, the Y pixel, the G pixel, the C pixel and the B pixel decrease in sequence, and a light wavelength of the W pixel may overlap light wavelengths of multiple primary color pixels. The R pixel, the Y pixel, the G pixel, the C pixel, the B pixel and the W pixel correspond to the R primary color, the Y primary color, the G primary color, the C primary color, the B primary color and the W primary color, respectively, and also correspond to the R primary color point, the Y primary color point, the G primary color point, the C primary color point, the B primary color point and the W primary color point in the chromatic diagram, respectively. As shown in FIG. 20, the M-th primary color pixel is the B pixel, and the (M−1)-th primary color pixel is the C pixel; in the second sub-mode, the display device can display any target color in a region (such as the filled region shown in FIG. 20) enclosed by multiple primary color points including the B primary color point and excluding the C primary color point, and the region may be any region located in an RYGB region (the W primary color point is located in the RYGB region) enclosed by the R primary color point, the Y primary color point, the G primary color point and the B primary color point. In this manner, when the display of some target colors inevitably needs the light emission of the B pixel with the shortest light wavelength, the C pixel with the second shortest light wavelength may not emit light so that cyan light with a relatively short wavelength can be reduced to increase the average wavelength of light and the damage of high-frequency (short-wavelength) light to the human eye can also be reduced to a certain extent.

Optionally, the M types of primary color pixels include a first primary color pixel, a second primary color pixel, . . . and an M-th primary color pixel, and a wavelength of the first primary color pixel is greater than at least some emission wavelengths of the second primary color pixel to the M-th primary color pixel; in the first display mode, the first primary color pixel is in the bright state.

Among all the primary color pixels, the first primary color pixel is a single-color primary color pixel with the longest light wavelength, and the light wavelength of the first primary color pixel may be greater than at least some light wavelengths of a mixed-color primary color pixel.

Specifically, in the first display mode, regardless of whether the primary color pixel with the shortest light wavelength is in the black state or the primary color pixel with the second shortest light wavelength is in the black state, the first primary color pixel with the longest light wavelength is in the bright state. This is conducive to reducing the light flux of the primary color with a relatively short wavelength, reducing the brightness of the primary color pixel with a relatively short light wavelength and increasing the average wavelength of light, thereby reducing the damage of high-frequency (short-wavelength) light to the human eye.

Optionally, the display mode of the display device further includes a second display mode; in the second display mode and the same pixel unit, V types of primary color pixels are in the bright state, (M-V) types of primary color pixels are in the black state, V is an integer, and 3<V<M; in the second display mode, light wavelengths of at least two types of the V types of primary color pixels in the bright state are less than at least some light wavelengths of the (M-V) types of primary color pixels in the black state.

V may be equal to N or may not be equal to N, that is, the number of types of primary color pixels in the bright state in the second display mode may be the same as or different from the number of types of primary color pixels in the bright state in the first display mode, which is not limited in the embodiment of the present disclosure.

Specifically, among the V types of primary color pixels in the bright state, light wavelengths of at least two types of primary color pixels are less than at least some light wavelengths of all the primary color pixels in the black state. That is, in the second display mode, among all the primary color pixels, both the primary color pixel with the shortest light wavelength and the primary color pixel with the second shortest light wavelength are in the bright state.

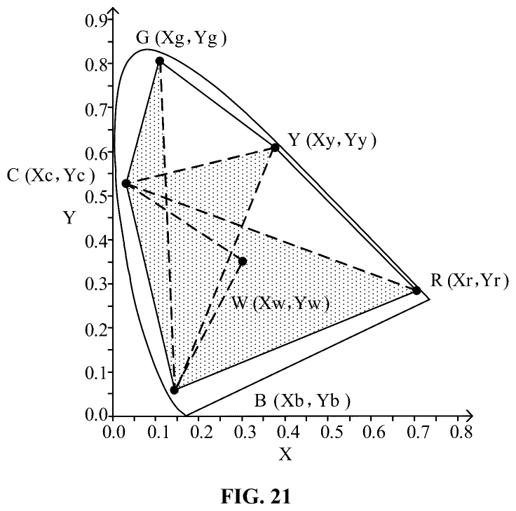

For example, M=6, the pixel unit includes a red (R) pixel, a yellow (Y) pixel, a green (G) pixel, a cyan (C) pixel, a blue (B) pixel and a white (W) pixel, light wavelengths of the R pixel, the Y pixel, the G pixel, the C pixel and the B pixel decrease in sequence, and a light wavelength of the W pixel may overlap light wavelengths of multiple primary color pixels. The R pixel, the Y pixel, the G pixel, the C pixel, the B pixel and the W pixel correspond to the R primary color, the Y primary color, the G primary color, the C primary color, the B primary color and the W primary color, respectively, and also correspond to the R primary color point, the Y primary color point, the G primary color point, the C primary color point, the B primary color point and the W primary color point in the chromatic diagram, respectively. As shown in FIG. 21, in the second display mode, the display device may display any target color in a region (such as the filled region shown in FIG. 21) enclosed by multiple primary color points including the B primary color point and the C primary color point. For example, the display device can display any target color in a CBG region, a CBY region, a CBR region and a CBW region. In this manner, in the second display mode, the display device can display a target color that cannot be displayed in the first display mode, thereby increasing the color gamut of the display device.

It is to be understood that the display device may also display any target color in a region enclosed by four or five primary color points including the B primary color point and the C primary color point. The examples are not described one by one in the present disclosure.

On the basis of the preceding embodiment, in the second display mode, at least some light wavelengths of some of the V types of primary color pixels in the bright state are at least greater than a light wavelength of one type of primary color pixel in the black state.

For example, the conditions that M=6 and the pixel unit includes an R pixel, a Y pixel, a G pixel, a C pixel, a B pixel and a W pixel continue to be used as an example. Light wavelengths of the R pixel, the Y pixel, the G pixel, the C pixel and the B pixel decrease in sequence, and some light wavelengths of the W pixel may be less than light wavelengths of the R pixel, the Y pixel, the G pixel and the C pixel. In the second display mode, the B primary color pixel and the C primary color pixel are in the bright state. In addition, one or more of the Y pixel, the R pixel and the W pixel may also be in the bright state so that the (M-V) types of primary color pixels in the black state at least include the G pixel and at least some light wavelengths of the Y pixel, the R pixel and the W pixel are greater than a light wavelength of the G pixel. In this manner, in the second display mode, when the B primary color pixel and the C primary color pixel emit light, a pixel with a relatively long light wavelength may also emit light, which is conducive to increasing the average wavelength of light and reducing high-frequency (short-wavelength) light, thereby reducing the damage to the human eye. The B pixel, the C pixel and the G pixel are prevented from emitting light simultaneously, which causes greater damage to the human eye.

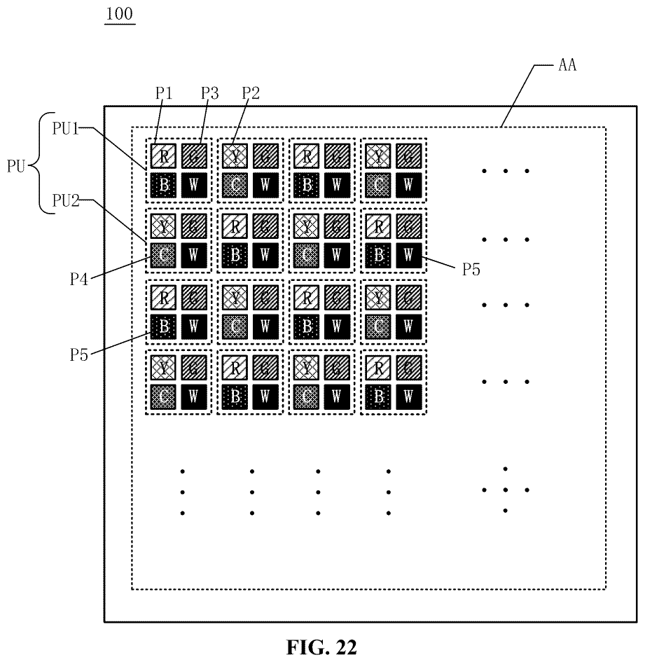

Optionally, FIG. 22 is a top view of another display device according to an embodiment of the present disclosure. Referring to FIG. 22, the pixel unit PU includes multiple sub-pixel units (PU1 and PU2), the multiple sub-pixel units (PU1 and PU2) of the display device 100 are arranged in an array, the same pixel unit PU includes the M types of primary color pixels (P1, P2, . . . and PM), the same sub-pixel unit (PU1 or PU2) includes K types of primary color pixels, and K<M.

For example, referring to FIG. 22, M=6, and K=4; the pixel unit PU may include a red (R) pixel, a yellow (Y) pixel, a green (G) pixel, a cyan (C) pixel, a blue (B) pixel and a white (W) pixel, the pixel unit PU may include a first sub-pixel unit PU1 and a second sub-pixel unit PU2, the first sub-pixel unit PU1 may include an R pixel, a G pixel, a B pixel and a W pixel, and the second sub-pixel unit PU2 may include a Y pixel, a G pixel, a C pixel and a W pixel. Setting the pixel unit PU as the multiple sub-pixel units (PU1 and PU2) and not setting the M types of primary color pixels in the same sub-pixel unit can set the minimum display unit (the sub-pixel unit) of the pixel array and set the number and arrangement of primary color pixels in the minimum display unit (the sub-pixel unit) according to an actual situation regardless of how many types of primary color pixels are included in the pixel unit PU, thereby ensuring that the display device can display a normal image. Multiple minimum display units (sub-pixel units) can form an actual pixel unit PU. When the target color is displayed, the target color can be synthesized through pixel rendering. For example, when primary color pixels in one sub-pixel unit (PU1 or PU2) cannot achieve the target color alone, primary color pixels of other sub-pixel units in the same pixel unit PU can be borrowed to supplement primary colors that cannot be presented by the current sub-pixel unit to achieve the target color. In addition, reducing the number of primary color pixels in the minimum display unit (the sub-pixel unit) is conducive to improving the resolution, increasing the transmittance of each primary color pixel in the minimum display unit (the sub-pixel unit) and reducing the amount of data transmission of the minimum display unit (the sub-pixel unit) to achieve low power consumption.

Optionally, the M types of primary color pixels correspond to M primary color points in a chromatic diagram, the chromatic diagram further includes E sub-regions delimited by multiple primary color points, E is an integer, and E≥2. Among at least part of the sub-regions, two sub-regions do not overlap with each other, the pixel unit includes the multiple sub-pixel units, and the sub-pixel unit includes multiple primary color pixels. In the same pixel unit, the primary color pixels in the sub-pixel unit correspond to primary color points in at least one of the sub-regions in the chromatic diagram, respectively.

The sub-region is delimited by at least three primary color points and at most (M−1) primary color points, and at least one sub-region is delimited by multiple primary color points excluding the M-th primary color point corresponding to the M-th primary color. For different sub-regions, the numbers of primary color points used for delimitation may be the same or different and are not limited in the embodiment of the present disclosure. In addition, among at least part of the sub-regions, two sub-regions do not overlap with each other, that is, at least one of the multiple primary color points for delimiting different sub-regions is different. In one embodiment of present disclosure, the E sub-regions of the chromatic diagram can cover the largest region enclosed by all the primary color points.

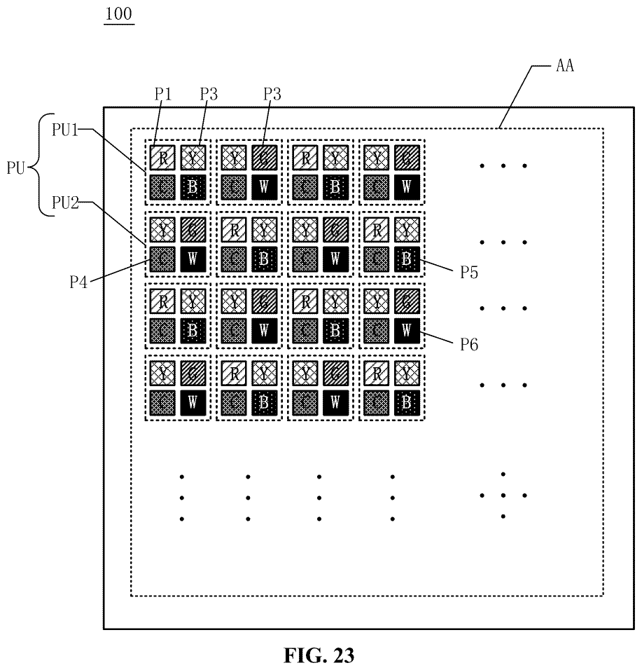

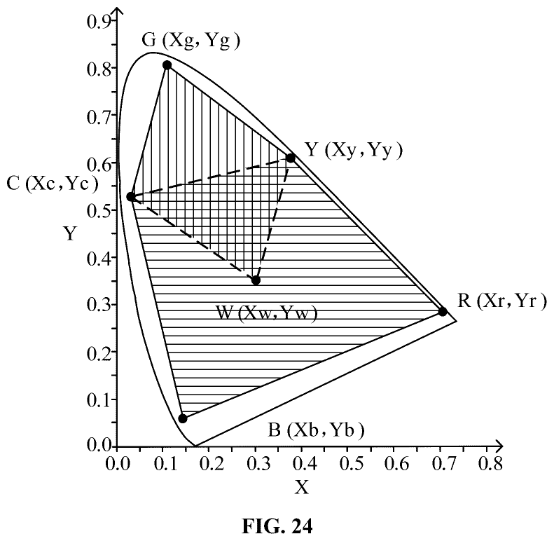

For example, M=6 and K=4 continue to be used as an example. FIG. 23 is a top view of another display device according to an embodiment of the present disclosure, and FIG. 24 is a schematic diagram of another chromatic diagram according to an embodiment of the present disclosure. Referring to FIGS. 23 and 24, the chromatic diagram includes a red (R) primary color point, a yellow (Y) primary color point, a green (G) primary color point, a cyan (C) primary color point, a blue (B) primary color point and a white (W) primary color point. Correspondingly, the pixel unit PU includes an R pixel, a Y pixel, a G pixel, a C pixel, a B pixel and a W pixel. The chromatic diagram further includes an RYCB region delimited by the R primary color point, the Y primary color point, the C primary color point and the B primary color point and a YGCW region delimited by the Y primary color point, the G primary color point, the C primary color point and the W primary color point. Correspondingly, the pixel unit PU includes a first sub-pixel unit PU1 and a second sub-pixel unit PU2. The first sub-pixel unit PU1 may include the R pixel, the Y pixel, the C pixel and the B pixel corresponding to the RYCB region, and the second sub-pixel unit PU2 may include the Y pixel, the G pixel, the C pixel and the W pixel corresponding to the YGCW region. The first sub-pixel unit PU1 can display any target color in the RYCB region, and the second sub-pixel unit PU2 can display any target color in the YGCW region. It is to be noted that different fill patterns in the chromatic diagram are only used for representing different sub-regions and are not used for limiting specific sub-regions.

In this manner, at least some target colors can be achieved by the sub-pixel unit (PU1 or PU2) alone so that the borrowing of the primary color pixels from other sub-pixel units in the same pixel unit PU can be reduced, which is conducive to uniform display and reducing color cast, thereby improving a display effect. When the E sub-regions of the chromatic diagram can cover the largest region enclosed by all the primary color points, as shown in FIGS. 23 and 24, it is conducive to achieving that any target color in the color gamut of the display device 100 can be achieved alone by the sub-pixel unit corresponding to the sub-region and conducive to improving a rendering effect, thereby further improving the display effect.

In one embodiment of present disclosure, in at least a portion of the display mode of the display device, in the same pixel unit, three types of primary color pixels are in the bright state and (M−3) types of primary color pixels are in the black state.

Specifically, regardless of how the primary color pixels of the multiple sub-pixel units in the pixel unit are arranged, when the target color is displayed, only three types of primary color pixels among the M types of primary color pixels in the pixel unit can be in the bright state. This is conducive to determining unique solutions of driving components of three primary colors corresponding to the three primary color pixels in the bright state, thereby simplifying a process of determining the drive voltages of the primary color pixels.

In another embodiment of present disclosure, each sub-region in the chromatic diagram is delimited by three primary color points; the pixel unit includes E sub-pixel units, and the sub-pixel unit includes three primary color pixels. In the same pixel unit, the primary color pixels in each sub-pixel unit correspond to the primary color points in each sub-region in the chromatic diagram, respectively.

Specifically, only three types of primary color pixels are set in the sub-pixel unit, and in the same sub-pixel unit, only one primary color pixel is set for each type of primary color pixel; the sub-pixel unit can independently display any target color in a sub-region delimited by three primary color points corresponding to three types of primary color pixels. On the one hand, only setting three primary color pixels in the sub-pixel unit is conducive to increasing the opening area of each primary color pixel and improving the transmittance and also conducive to reducing the amount of data transmission of the sub-pixel unit to achieve low power consumption. On the other hand, the sub-pixel unit corresponding to the sub-region where the target color point of the target color is located can display the target color alone, and three primary color pixels in the bright state are located in the same sub-pixel unit, which is conducive to reducing the color cast and improving the display effect.

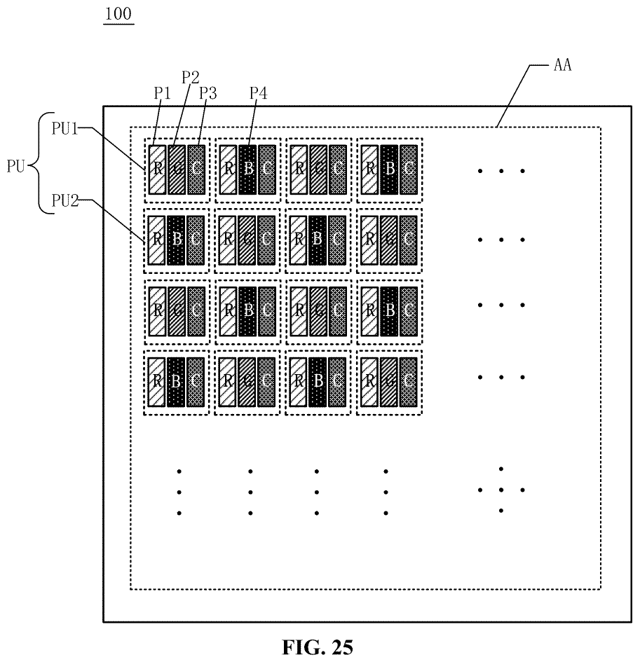

For example, M=4, and E=2. FIG. 25 is a top view of another display device according to an embodiment of the present disclosure. Referring to FIGS. 7 and 25, the chromatic diagram includes a red (R) primary color point, a green (G) primary color point, a cyan (C) primary color point and a blue (B) primary color point. Correspondingly, the pixel unit PU includes an R pixel, a G pixel, a C pixel and a B pixel. The chromatic diagram further includes an RGC region delimited by the R primary color point, the G primary color point and the C primary color point. Correspondingly, the pixel unit PU includes a first sub-pixel unit PU1 and a second sub-pixel unit PU2. The first sub-pixel unit PU1 may include the R pixel, the G pixel and the C pixel corresponding to the RGC region, and the second sub-pixel unit PU2 may include the R pixel, the C pixel and the B pixel corresponding to the RCB region. The first sub-pixel units PU1 and the second sub-pixel units PU2 are alternately arranged in sequence along a row direction, and/or the first sub-pixel units and the second sub-pixel units are alternately arranged in sequence along a column direction. The first sub-pixel unit PU1 can display any target color located in the RGC region, and the second sub-pixel unit PU2 can display any target color located in the RCB region. When a target color of the RGC region needs to be displayed, the first sub-pixel unit PU1 in the pixel unit PU can be controlled to display the target color of the RGC region independently. When a target color of the RCB region needs to be displayed, a rendering technique may be used, the B pixel of the second sub-pixel unit PU2 may be borrowed, and the second sub-pixel unit PU2 in the pixel unit PU may be controlled to display the target color of the RCB region independently.

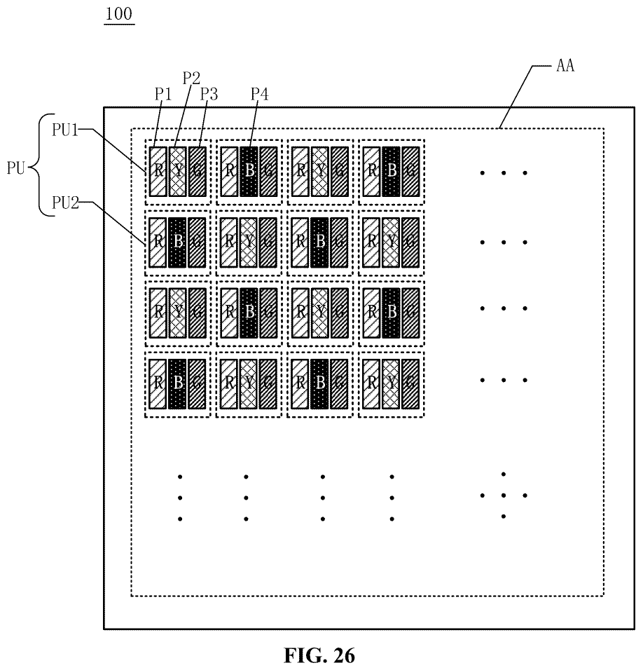

In other embodiments, M=4, and E=2. Referring to FIGS. 8 and 26, the chromatic diagram may include a red (R) primary color point, a yellow (Y) primary color point, a green (G) primary color point and a blue (B) primary color point. Correspondingly, the pixel unit may include an R pixel, a Y pixel, a G pixel and a B pixel. The chromatic diagram may include an RYG region delimited by the R primary color point, the Y primary color point and the B primary color point and an RGB region delimited by the R primary color point, the G primary color point and the B primary color point, the first sub-pixel unit PU1 of the pixel unit PU may include the R pixel, the Y pixel and the G pixel corresponding to the RYG region, and the second sub-pixel unit PU2 of the pixel unit PU may include the R pixel, the G pixel and the B pixel corresponding to the RGB region.

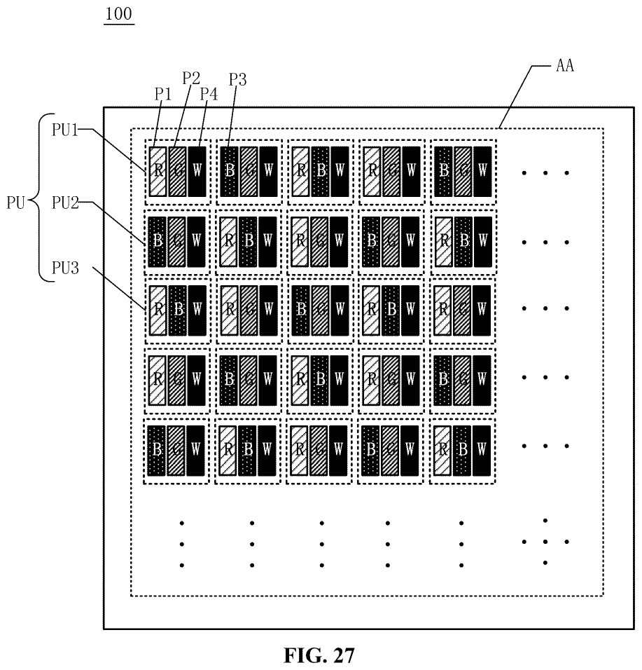

When M=4, E=3 is also possible. Referring to FIGS. 9 and 27, the chromatic diagram may include an R primary color point, a G primary color point, a B primary color point and a white (W) primary color point. Correspondingly, the pixel unit may include an R pixel, a G pixel, a B pixel and a W pixel. The sub-regions of the chromatic diagram may include an RGW region delimited by the R primary color point, the G primary color point and the W primary color point, a GBW region delimited by the G primary color point, the B primary color point and the W primary color point and an RBW region delimited by the R primary color point, the B primary color point and the W primary color point. The pixel unit PU may include three sub-pixel units. The first sub-pixel unit PU1 may include the R pixel, the G pixel and the W pixel corresponding to the RGW region, the second sub-pixel unit PU2 may include the G pixel, the B pixel and the W pixel corresponding to the GBW region, and the third sub-pixel unit PU3 may include the R pixel, the B pixel and the W pixel corresponding to the RBW region. Primary color pixels can be shared through pixel rendering to improve the transmittance and the resolution and reduce the power consumption. Moreover, white pixels are added, which is conducive to the balance of white images and improving the display effect.

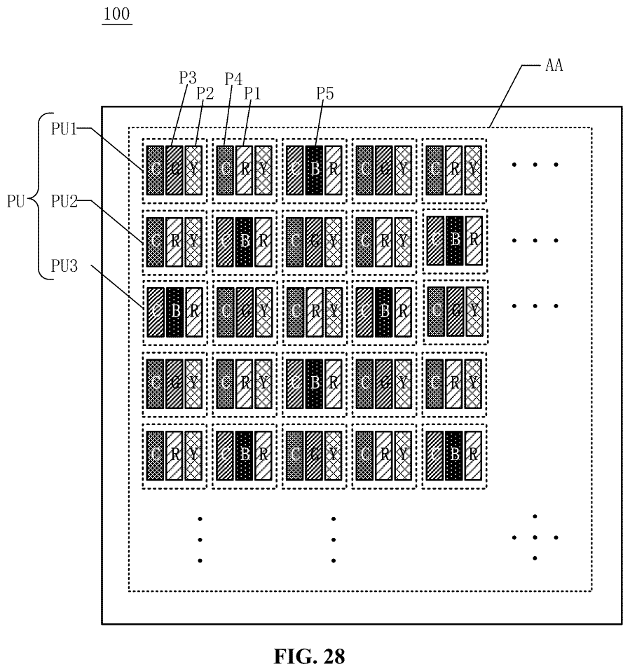

In addition, when E=3, M=5 is also possible. Referring to FIGS. 11 and 28, the chromatic diagram may include an R primary color point, a Y primary color point, a G primary color point, a C primary color point and a B primary color point. Accordingly, the pixel unit may include an R pixel, a Y pixel, a G pixel, a C pixel and a B pixel. The sub-regions of the chromatic diagram may include a YGC region delimited by the Y primary color point, the G primary color point and the C primary color point, an RYC region delimited by the R primary color point, the Y primary color point and the C primary color point and an RCB region delimited by the R primary color point, the C primary color point and the B primary color point. The pixel unit PU may include three sub-pixel units. The first sub-pixel unit PU1 may include the Y pixel, the G pixel and the C pixel corresponding to the YGC region, the second sub-pixel unit PU2 may include the R pixel, the Y pixel and the C pixel corresponding to the RYC region, and the third sub-pixel unit PU3 may include the R pixel, the C pixel and the B pixel corresponding to the RCB region. The types of primary color pixels is increased, but the number of sub-pixel units is not increased to reduce effects on the transmittance and the amount of data transmission, thereby achieving high transmittance and low power consumption.

As can be seen from the above contents, for M<5, each sub-region in the chromatic diagram is delimited by three primary color points, and in the same pixel unit, when the primary color pixels in each sub-pixel unit correspond to the primary color points in each sub-region in the chromatic diagram, respectively, 2≤E≤3, that is, the pixel unit includes at most three sub-pixel units; for M≥5, each sub-region in the chromatic diagram is delimited by three primary color points, and in the same pixel unit, when the primary color pixels in each sub-pixel unit correspond to the primary color points in each sub-region in the chromatic diagram, E≥3, that is, the pixel unit at least includes three sub-pixel units. If three primary color points are still used for delimiting the sub-regions when M≥5, E≥4. If the primary color pixels in the sub-pixel unit correspond to the primary color points in the sub-region, respectively, the number of sub-pixel units in the same pixel unit is relatively large. When rendering is performed, the borrowed primary color pixel may be far away, resulting in an effect on a rendering effect. In this case, the number of primary color points delimiting the sub-regions can be increased, and/or the number of sub-regions corresponding to the primary color pixels in the sub-pixel unit can be increased, thereby reducing the number of sub-pixel units in the pixel unit and improving the rendering display effect.

In one embodiment of present disclosure, the M types of primary color pixels correspond to M primary color points in a chromatic diagram, the chromatic diagram further includes E sub-regions delimited by four primary color points, E is an integer, and E≥2. Among at least part of the sub-regions, two sub-regions do not overlap with each other; the pixel unit includes E sub-pixel units, and the sub-pixel unit includes four primary color pixels; in the same pixel unit, the four primary color pixels in each sub-pixel unit correspond to the four primary color points in each sub-region in the chromatic diagram, respectively.

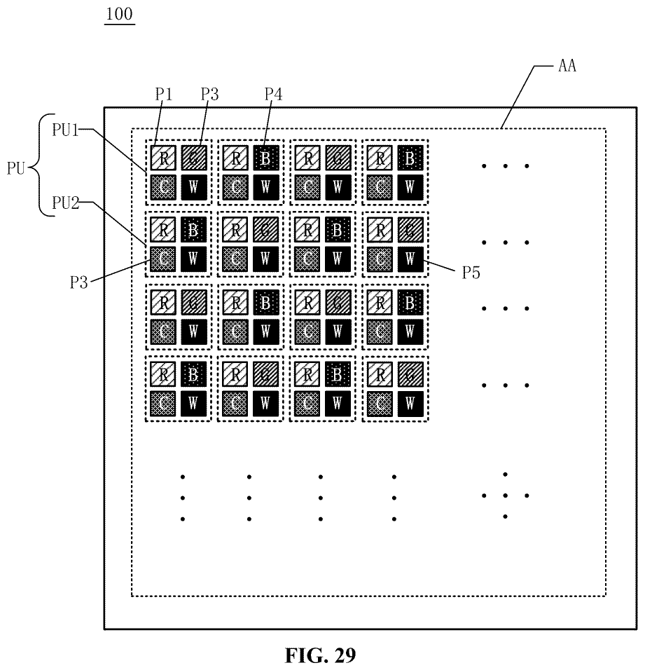

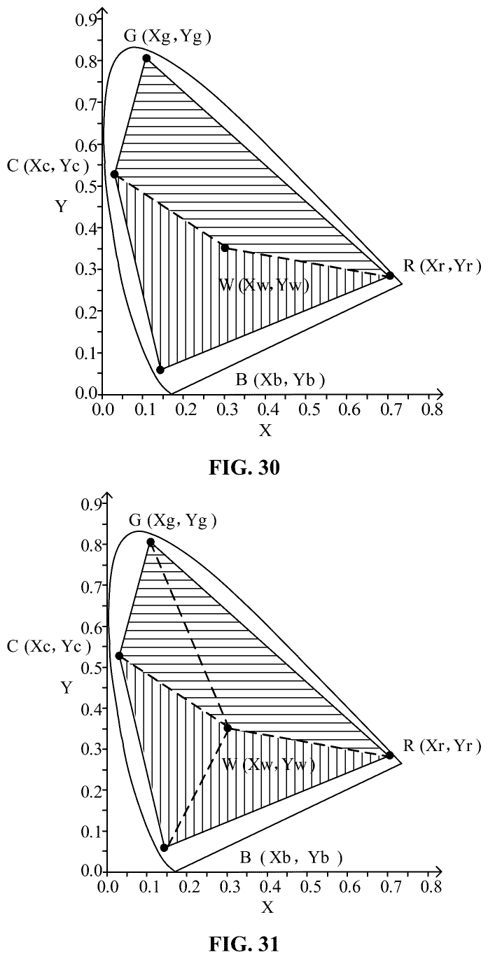

For example, M=5, and E=2. FIG. 29 is a top view of another display device according to an embodiment of the present disclosure, and FIG. 30 is a schematic diagram of another chromatic diagram according to an embodiment of the present disclosure. Referring to FIGS. 29 and 30, the chromatic diagram may include a red (R) primary color point, a green (G) primary color point, a cyan (C) primary color point, a blue (B) primary color point and a white (W) primary color point. Correspondingly, the pixel unit may include an R pixel, a G pixel, a C pixel, a B pixel and a W pixel. The sub-regions of the chromatic diagram may include an RGCW region delimited by the R primary color point, the G primary color point, the C primary color point and the W primary color point and an RCBW region delimited by the R primary color point, the C primary color point, the B primary color point and the W primary color point. The pixel unit PU may include two sub-pixel units. The first sub-pixel unit PU1 may include the R pixel, the G pixel, the C pixel and the W pixel corresponding to the RGCW region, and the second sub-pixel unit PU2 may include the R pixel, the C pixel, the B pixel and the W pixel corresponding to the RCBW region. The first sub-pixel units and the second sub-pixel units are alternately arranged in sequence along a row direction, and/or the first sub-pixel units and the second sub-pixel units are alternately arranged in sequence along a column direction. The first sub-pixel unit PU1 can display any target color in the RGCW region independently, and the second sub-pixel unit PU2 can display any target color in the RCBW region independently.

In this manner, when many types of primary color pixels are set in the pixel unit, it is conducive to reducing the number of sub-pixel units in the pixel unit, thereby reducing the distance from the borrowed primary color pixels during rendering and improving the display effect. It is to be noted that although the sub-pixel unit includes four primary color pixels, in at least some display modes, at least one primary color pixel in the sub-pixel unit is in the black state, that is, only three of the four primary color pixels in the sub-pixel unit may be in the bright state, which is conducive to determining the unique solutions of the driving components of the primary colors.

In another embodiment of present disclosure, each sub-region in the chromatic diagram is delimited by three primary color points, and E is an even number greater than 2. The pixel unit includes E/2 sub-pixel units, and the sub-pixel unit includes four primary color pixels. In the same pixel unit, the four primary color pixels in each sub-pixel unit correspond to the primary color points in two adjacent sub-regions in the chromatic diagram, respectively.

For example, M=5, and E=4. FIG. 31 is a schematic diagram of another chromatic diagram according to an embodiment of the present disclosure. Referring to FIGS. 29 and 31, the chromatic diagram may include an R primary color point, a G primary color point, a C primary color point, a B primary color point and a W primary color point. Correspondingly, the pixel unit may include an R pixel, a G pixel, a C pixel, a B pixel and a W pixel. The sub-regions of the chromatic diagram may include an RGW region delimited by the R primary color point, the G primary color point and the W primary color point, a GCW region delimited by the G primary color point, the C primary color point and the W primary color point, a CBW region delimited by the C primary color point, the B primary color point and the W primary color point and a RBW region delimited by the R primary color point, the B primary color point and the W primary color point. The pixel unit PU may include two sub-pixel units. The first sub-pixel unit PU1 may include the R pixel, the G pixel, the C pixel and the W pixel corresponding to the RGW region and the GCW region, and the second sub-pixel unit PU2 may include the R pixel, the C pixel, the B pixel and the W pixel corresponding to the CBW region and the RBW region. In other embodiments, when E=6 or 8, the pixel unit may include three or four sub-pixel units. Each of the sub-pixel unit includes four primary color pixels, and the four primary color pixels in the sub-pixel unit correspond to four primary color points in two adjacent sub-regions in the chromatic diagram, respectively. The examples are not described one by one in the present disclosure.

When many types of primary color pixels are set in the pixel unit and/or many sub-regions are delimited, primary color pixels of one sub-pixel unit may correspond to primary color points in two adjacent sub-regions, or the number of sub-pixel units in the pixel unit may also be reduced, thereby reducing the distance from the borrowed primary color pixels during rendering and improving the display effect.

In another embodiment of present disclosure, each sub-region in the chromatic diagram is delimited by three primary color points, and E is an even number greater than 2; the pixel unit includes two sub-pixel units, and the sub-pixel unit includes (2+E/2) primary color pixels; in the same pixel unit, the (2+E/2) primary color pixels in each sub-pixel unit correspond to (2+E/2) primary color points in E/2 adjacent sub-regions in the chromatic diagram, respectively.

For example, M=5, and E=4. With continued reference to FIGS. 29 and 31, the chromatic diagram may include an R primary color point, a G primary color point, a C primary color point, a B primary color point and a W primary color point, and the pixel unit may include an R pixel, a G pixel, a C pixel, a B pixel and a W pixel. The sub-regions of the chromatic diagram may include an RGW region, a GCW region, a CBW region and an RBW region. The first sub-pixel unit PU1 of the pixel unit PU may include the R pixel, the G pixel, the C pixel and the W pixel corresponding to the RGW region and the GCW region, and the second sub-pixel unit PU2 may include the R pixel, the C pixel, the B pixel and the W pixel corresponding to the CBW region and the RBW region. In other embodiments, when E=6, the pixel unit still includes only two sub-pixel units, the sub-pixel unit includes five primary color pixels, and the five primary color pixels in the sub-pixel unit correspond to five primary color points in three adjacent sub-regions in the chromatic diagram, respectively; when E=8, the pixel unit still includes only two sub-pixel units, the sub-pixel unit includes six primary color pixels, and the six primary color pixels in the sub-pixel unit correspond to six primary color points in four adjacent sub-regions in the chromatic diagram, respectively. The examples are not described one by one in the present disclosure.

When many types of primary color pixels are set in the pixel unit and/or many sub-regions are delimited, the pixel unit may always include two sub-pixel units, and the primary color pixels in the sub-pixel unit may correspond to the primary color points in multiple adjacent sub-regions, respectively, or the number of sub-pixel units in the pixel unit may also be reduced, thereby reducing the distance from the borrowed primary color pixels during rendering and improving the display effect.

On the basis of the preceding embodiment, in the same pixel unit, at least one sub-pixel unit includes a blue pixel, and at least one sub-pixel unit does not include a blue pixel.

For example, with continued reference to FIGS. 29 to 31, the chromatic diagram may include an R primary color point, a G primary color point, a C primary color point, a B primary color point and a W primary color point, and the pixel unit may include an R pixel, a G pixel, a C pixel, a B pixel and a W pixel. Four primary color pixels in the sub-pixel unit correspond to four primary color points in the chromatic diagram, respectively, and the four primary color points corresponding to the sub-pixel unit can form a sub-pixel unit region, that is, a region with the same fill pattern in the chromatic diagram. The R primary color point, the C primary color point and the W primary color point are all located in two sub-pixel unit regions so that two sub-pixel units in the same pixel unit both include the R pixel, the C pixel and the W pixel, that is, each of the number of R pixels, the number of C pixels and the number of W pixels in the pixel unit PU is two. At least one sub-pixel unit region includes a B primary color point corresponding to a blue pixel so that at least one sub-pixel unit may include the blue pixel. At least one sub-pixel unit region does not include a B primary color point corresponding to a blue pixel so that at least one sub-pixel unit does not include the blue pixel. In this manner, reducing the number of blue pixels in the pixel unit PU is conducive to reducing blue light, thereby reducing the damage of blue light to the human eye.

As can be seen from the above contents, when M=5 and/or the number E of sub-regions in the chromatic diagram is an even number, the number of primary color points delimiting the sub-regions can be increased, and/or the number of primary color pixels in the sub-pixel unit can be increased, thereby reducing the number of sub-pixel units in the pixel unit to improve the rendering display effect, that is, when M=5 and/or the number E of sub-regions in the chromatic diagram is an even number, the primary color pixels of the sub-pixel unit in the pixel unit may be set correspondingly according to the primary color points in the sub-region of the chromatic diagram. However, when M=6 and/or the number E of sub-regions in the chromatic diagram is an odd number, it is no longer applicable to set the primary color pixels of the sub-pixel unit in the pixel unit correspondingly according to the primary color points in the sub-region of the chromatic diagram. In this case, the primary color pixels of the sub-pixel unit in the pixel unit may be set according to the types of primary color pixels in the pixel unit.

In one embodiment of present disclosure, M is an even number; the pixel unit includes two sub-pixel units, and the sub-pixel unit includes M/2 primary color pixels; in the same pixel unit, the two sub-pixel units do not include the same primary color pixels.

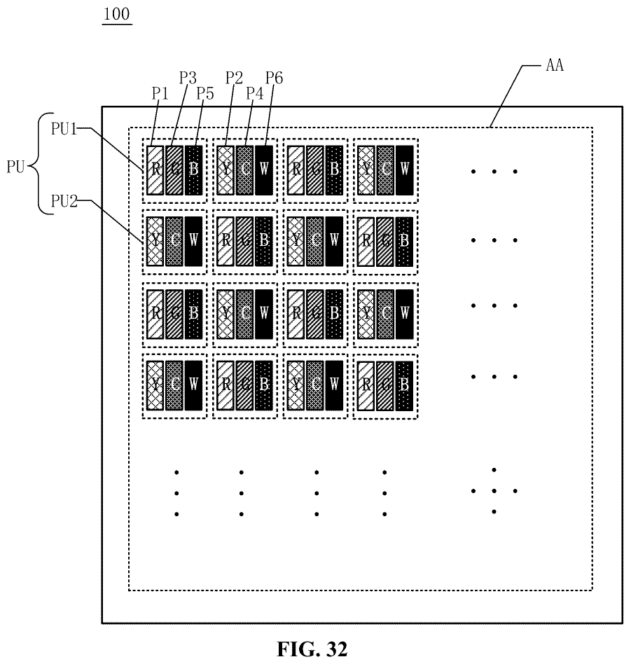

For example, M=6. FIG. 32 is a top view of another display device according to an embodiment of the present disclosure. Referring to FIG. 32, the pixel unit PU may include a red (R) pixel, a yellow (Y) pixel, a green (G) pixel, a cyan (C) pixel, a blue (B) pixel and a white (W) pixel, the pixel unit PU may include a first sub-pixel unit PU1 and a second sub-pixel unit PU2, the first sub-pixel unit PU1 includes an R pixel, a G pixel and a B pixel, and the second sub-pixel unit PU2 includes a C pixel, a B pixel and a W pixel. The first sub-pixel units and the second sub-pixel units are alternately arranged in sequence along a row direction, and/or the first sub-pixel units and the second sub-pixel units are alternately arranged in sequence along a column direction.

In this manner, the numbers of primary color pixels of different sub-pixel units in the same pixel unit may be the same, which is conducive to the pixel arrangement, thereby improving the display effect and avoiding that different numbers of primary color pixels of different sub-pixel units in the same pixel unit affect a pixel arrangement effect and cause non-uniform display.

In addition, compared with the preceding embodiment, in this embodiment, the increase in the types of primary color pixels does not significantly affect the transmittance of the pixel and the amount of data transmission, which is conducive to low power consumption of the display device.

On the basis of the preceding embodiment, M/2 primary color pixels in the sub-pixel unit correspond to M/2 primary color points in a chromatic diagram, respectively, and the M/2 primary color points corresponding to the sub-pixel unit form a sub-pixel unit region; in the same pixel unit, for two sub-pixel units, a sub-pixel unit region formed by M/2 primary color points corresponding to one sub-pixel unit overlaps a sub-pixel unit region formed by M/2 primary color points corresponding to the other sub-pixel unit.

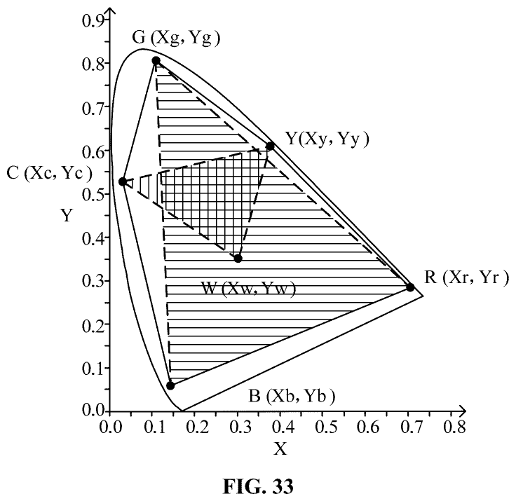

For example, FIG. 33 is a schematic diagram of another chromatic diagram according to an embodiment of the present disclosure. Referring to FIGS. 32 and 33, M=6, and the pixel unit includes an R pixel, a Y pixel, a G pixel, a C pixel, a B pixel and a W pixel. Accordingly, the chromatic diagram includes an R primary color point, a Y primary color point, a G primary color point, a C primary color point, a B primary color point and a W primary color point. A sub-pixel unit region formed by the R primary color point, the G primary color point and the B primary color point corresponding to the first sub-pixel unit PU1 is an RGB region, a sub-pixel unit region formed by the C primary color point, the B primary color point and the W primary color point corresponding to the second sub-pixel unit PU2 is a CBW region, and the RGB region overlaps the CBW region. In the same pixel unit, for two sub-pixel units, a sub-pixel unit region formed by M/2 primary color points corresponding to one sub-pixel unit overlaps a sub-pixel unit region formed by M/2 primary color points corresponding to the other sub-pixel unit so that the sub-pixel unit region formed by the M/2 primary color points corresponding to the sub-pixel unit is relatively large and more target colors can be displayed independently. During pixel rendering, the borrowing of the primary color pixels from adjacent sub-pixel units can be reduced, which is conducive to reducing the color cast and improving the display effect, thereby avoiding that the display of all the target colors needs rendering. For the borrowing of the primary color pixels from adjacent sub-pixel units, if the distance from the borrowed primary color pixels is relatively long, the rendering effect may not be good, and the color cast is easy to cause.

In another embodiment of present disclosure, M is an odd number, the primary color pixels of the display device include at least a white pixel. The pixel unit includes two sub-pixel units, the sub-pixel unit includes (M+1)/2 primary color pixels, and each sub-pixel unit includes the white pixel.

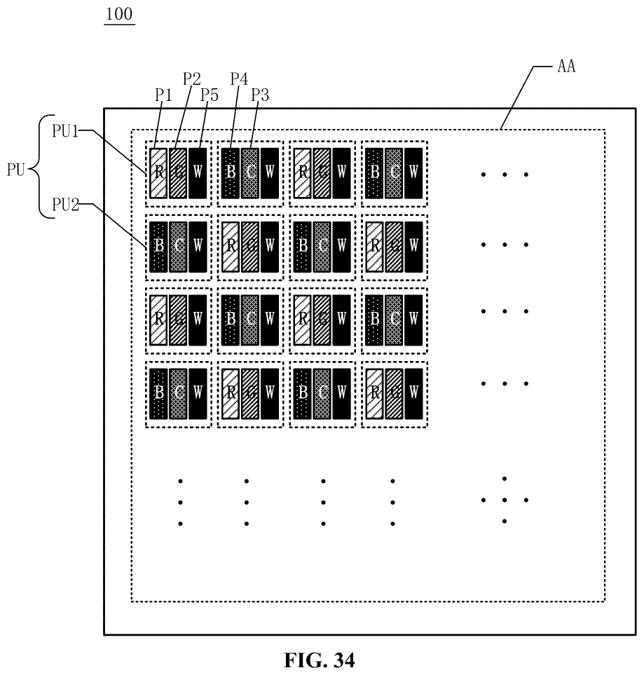

For example, M=5. FIG. 34 is a top view of another display device according to an embodiment of the present disclosure. Referring to FIG. 34, the pixel unit PU may include a red (R) pixel, a green (G) pixel, a cyan (C) pixel, a blue (B) pixel and a white (W) pixel, the pixel unit PU may include a first sub-pixel unit PU1 and a second sub-pixel unit PU2, the first sub-pixel unit PU1 includes an R pixel, a G pixel and a W pixel, and the second sub-pixel unit PU2 includes a C pixel, a B pixel and a W pixel. The first sub-pixel units and the second sub-pixel units are alternately arranged in sequence along a row direction, and/or the first sub-pixel units and the second sub-pixel units are alternately arranged in sequence along a column direction.

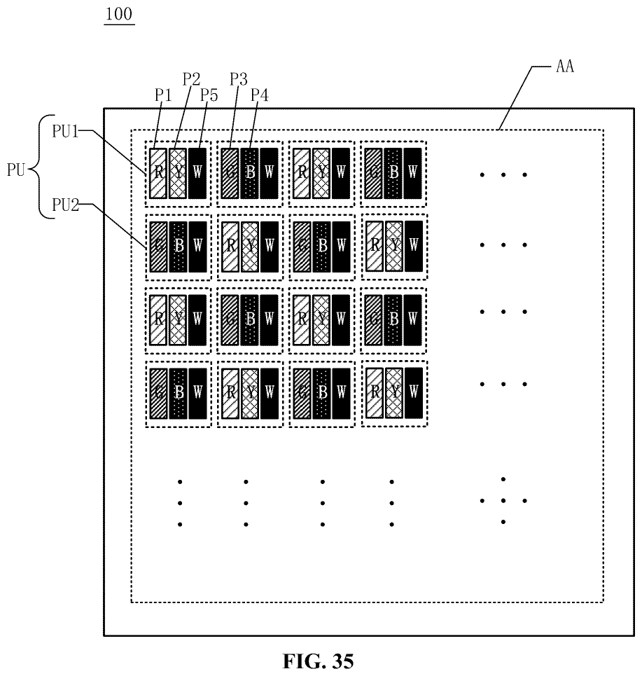

In other embodiment, FIG. 35 is a top view of another display device according to an embodiment of the present disclosure. Referring to FIG. 35, the pixel unit PU may also include a red (R) pixel, a yellow (Y) pixel, a green (G) pixel, a blue (B) pixel and a white (W) pixel, the pixel unit PU may include a first sub-pixel unit PU1 and a second sub-pixel unit PU2, the first sub-pixel unit PU1 includes an R pixel, a Y pixel and a W pixel, and the second sub-pixel unit PU2 includes a G pixel, a B pixel and a W pixel. The first sub-pixel units and the second sub-pixel units are alternately arranged in sequence along a row direction, and/or the first sub-pixel units and the second sub-pixel units are alternately arranged in sequence along a column direction.

In this manner, when the number of types of primary color pixels is an odd number, the same pixel unit may include (M+1) primary color pixels, and the white pixel is used for filling a sub-pixel unit with a small number of primary color pixels so that the same number of primary color pixels can be set in different sub-pixel units, which is conducive to pixel arrangement; two sub-pixel units both include the white pixel, and the white pixel is repeated, which is conducive to increasing white light, thereby increasing the display effect and reducing the color cast.

It is to be noted that increasing the number of primary color points delimiting the sub-regions and/or increasing the number of primary color pixels in the sub-pixel unit is not limited to the case where M is relatively large and/or E is relatively large and is also applicable to the case where M is relatively small and/or E is relatively small. Similarly, setting the primary color pixels of the sub-pixel unit in the pixel unit according to the types of primary color pixels in the pixel unit is not limited to case where M=6 and/or the number E of sub-pixel regions in the chromatic diagram is an odd number, when M is another integer greater than 3 and/or the number E of sub-pixel regions in the chromatic diagram is an even number, the primary color pixels of the sub-pixel unit in the pixel unit can also be set according to the types of primary color pixels in the pixel unit.

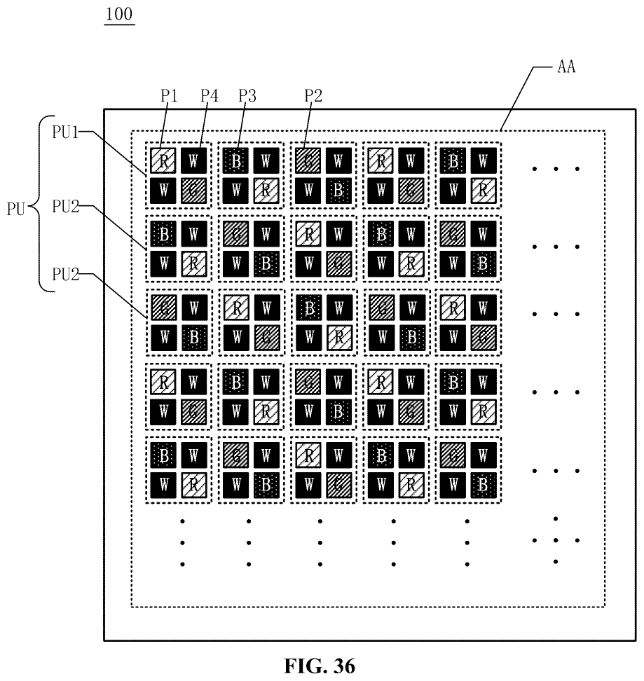

In one embodiment of present disclosure, M=4 is used as an example. FIG. 36 is a top view of another display device according to an embodiment of the present disclosure. Referring to FIG. 36, the pixel unit includes a red (R) pixel, a green (G) pixel, a blue (B) pixel and a white (W) pixel, the display device 100 includes first pixel units PU1, second pixel units PU2 and third pixel units PU3 that are arranged in an array, the first pixel unit PU1 includes an R pixel, a G pixel and two W pixels, the second pixel unit PU2 includes an R pixel, a B pixel and two W pixels, and the third pixel unit PU3 includes a G pixel, a B pixel and two W pixels. The first pixel units, the second pixel units and the third pixel units are alternately arranged in sequence along a row direction, and/or the first pixel units, the second pixel units and the third pixel units are alternately arranged in sequence along a column direction.

In the pixel arrangement shown in FIG. 36, when M=4, three sub-pixel units (PU1, PU2 and PU3) are configured to form a pixel unit PU, and the primary color pixels can be shared through pixel rendering. The pixel arrangement shown in FIG. 36 uses an arrangement combination of W pixels and traditional R pixels, G pixels and B pixels. Three sub-pixel units (PU1, PU2 and PU3) of the same pixel unit PU include two groups of R pixels, G pixels and B pixels, thereby achieving rich color display and increasing a proportion of white pixels in the pixel unit PU. Moreover, white pixels are designed diagonally in the sub-pixel unit, which is conducive to the display uniformity of the while image and improving the display effect.

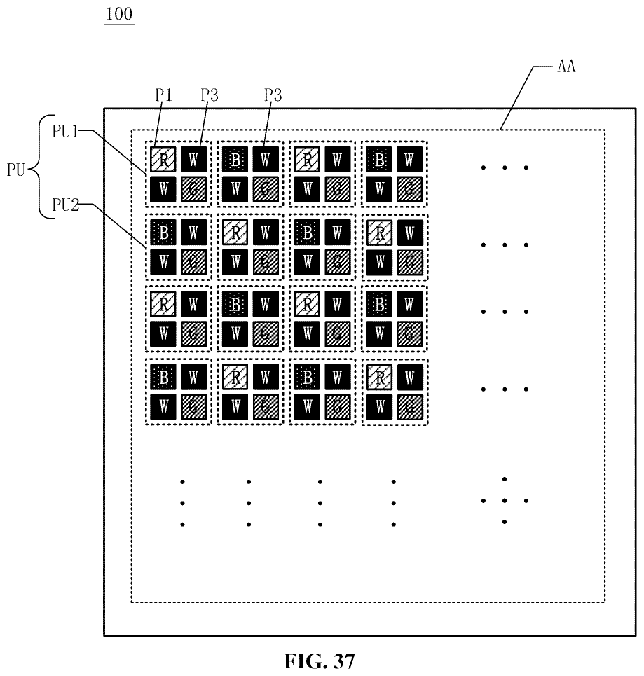

In another embodiment of present disclosure, M=4 continues to be used as an example. FIG. 37 is a top view of another display device according to an embodiment of the present disclosure. Referring to FIG. 37, the pixel unit includes a red (R) pixel, a green (G) pixel, a blue (B) pixel and a white (W) pixel, the display device 100 includes first pixel units PU1 and second pixel units PU2 that are arranged in an array, the first pixel unit PU1 includes an R pixel, a G pixel and two W pixels, and the second pixel unit PU2 includes a B pixel, a G pixel and two W pixels. The first pixel units and the second pixel units are alternately arranged in sequence along a row direction, and/or the first pixel units and the second pixel units are alternately arranged in sequence along a column direction.

In the pixel arrangement shown in FIG. 37, when M=4, two sub-pixel units (PU1 and PU2) are set to form a pixel unit PU, and the primary color pixels can be shared through pixel rendering. The pixel arrangement shown in FIG. 37 uses an arrangement combination of W pixels and existing R pixels, G pixels and B pixels. Two sub-pixel units (PU1 and PU2) of the same pixel unit PU include one groups of R pixels, G pixels and B pixels, thereby achieving rich color display and increasing a proportion of white pixels in the pixel unit PU. Moreover, white pixels are designed diagonally in the sub-pixel unit, which is conducive to the display uniformity of the while image and improving the display effect.

It is to be noted that the preceding are preferred embodiments of the present disclosure and technical principles used therein. It will be understood by those skilled in the art that the present disclosure is not limited to the specific embodiments described herein. Those skilled in the art can make various apparent modifications, adaptations and substitutions without departing from the scope of the present disclosure. Therefore, while the present disclosure is described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. An image conversion method, comprising:
acquiring a target color, and determining a target color point of the target color in a chromatic diagram, wherein the chromatic diagram comprises M primary color points, the M primary color points correspond to M primary colors, M is an integer, and M≥4;
defining M driving components (D01, D02, . . . and D0M) corresponding to the M primary colors and a relationship equation between a color coordinate (X0, Y0, Z0) of the target color point and a color coordinate (Xi, Yi, Zi) of each of the M primary color points: (X0, Y0, Z0)=D01*(X1, Y1, Z1)+D02*(X2, Y2, Z2)+ . . . +D0M*(XM, YM, ZM), wherein 1≤i≤M, and i is an integer; and
determining a first value range of a first driving component D01 according to the relationship equation, setting the first driving component D01 to a maximum value within the first value range, and determining values of remaining (M−1) driving components; and/or determining an M-th value range of an M-th driving component D0M according to the relationship equation, setting the M-th driving component D0M to a minimum value within the M-th value range, and determining values of remaining (M−1) driving components;
wherein the M primary colors comprise a first primary color, a second primary color, . . . and an M-th primary color, a wavelength of the first primary color is greater than at least some wavelengths of the second primary color to the M-th primary color, and a wavelength of the M-th primary color is less than at least some wavelengths of the first primary color to an (M−1)-th primary color.

2. The image conversion method according to claim 1, wherein the target color point comprises a first target color point; and
when the target color point is the first target color point, the M-th driving component D0M=0.

3. The image conversion method according to claim 1, wherein M≥5;
determining the first value range of the first driving component D01 according to the relationship equation, setting the first driving component D01 to the maximum value within the first value range, and determining the values of the remaining (M−1) driving components comprise:
determining the first value range of the first driving component D01 according to the relationship equation, and setting the first driving component D01 to the maximum value within the first value range; sequentially setting the values of the remaining driving components in ascending order of numbers until three driving components are remained; determining the remaining three driving components according to the relationship equation and the set values of the driving components; and
determining the M-th value range of the M-th driving component D0M according to the relationship equation, setting the M-th driving component D0M to the minimum value within the M-th value range, and determining the values of the remaining (M−1) driving components comprise:
determining the M-th value range of the M-th driving component D0M according to the relationship equation, and setting the M-th driving component D0M to the minimum value within the M-th value range; sequentially setting the values of the remaining driving components in descending order of numbers until three driving components are remained; determining the remaining three driving components according to the relationship equation and the set values of the driving components.

4. The image conversion method according to claim 1, wherein M=5;
determining the first value range of the first driving component D01 according to the relationship equation, setting the first driving component D01 to the maximum value within the first value range, and determining the values of the remaining (M−1) driving components comprise:
determining the first value range of the first driving component D01 according to the relationship equation, and setting the first driving component D01 to the maximum value within the first value range; determining a fifth value range of a fifth driving component D05 according to the relationship equation and the first driving component D01, and setting the fifth driving component D05 to a minimum value within the fifth value range; determining the remaining three driving components according to the relationship equation, the first driving component D01 and the fifth driving component D05; and
determining the M-th value range of the M-th driving component D0M according to the relationship equation, setting the M-th driving component D0M to the minimum value within the M-th value range, and determining the values of the remaining (M−1) driving components comprise:
determining the fifth value range of the fifth driving component D05 according to the relationship equation, and setting the fifth driving component D05 to the minimum value within the fifth value range; determining the first value range of the first driving component D01 according to the relationship equation and the fifth driving component D05, and setting the first driving component D01 to the maximum value within the first value range; determining remaining three driving components according to the relationship equation, the first driving component D01 and the fifth driving component D05.

5. The image conversion method according to claim 1, wherein M≥5;
determining the M-th value range of the M-th driving component D0M according to the relationship equation, setting the M-th driving component D0M to the minimum value within the M-th value range, and determining the values of the remaining (M−1) driving components comprise:
determining the M-th value range of the M-th driving component D0M according to the relationship equation, setting the M-th driving component D0M to the minimum value within the M-th value range; determining a first value range of a first driving component D01 according to the relationship equation and the M driving component D0M, and setting the first driving component D01 to a minimum value within the first value range; determining remaining (M−2) driving components according to the relationship equation, the first driving component D01 and the M driving component D0M.

6. The image conversion method according to claim 1, wherein the first primary color is a red primary color, and the M-th primary color is a blue primary color.

7. An image conversion method, comprising:
acquiring a target color, and determining a target color point of the target color in a chromatic diagram, wherein the chromatic diagram comprises M primary color points, the M primary color points correspond to M primary colors, M is an integer, and M≥4; the chromatic diagram further comprises E sub-regions delimited by a plurality of primary color points, E is an integer, and E≥2; among at least part of the E sub-regions, two sub-regions do not overlap with each other;
determining primary colors required to form the target color corresponding to the target color point according to a positional relationship between the target color point and each of the E sub-regions, denoting each of the primary colors as a first-type primary color, and denoting each of the other primary colors as a second-type primary color; and
determining a driving component corresponding to the first-type primary color according to a color coordinate of the target color point and a color coordinate of a primary color point of the first-type primary color, and setting a driving component corresponding to the second-type primary color to zero;
wherein the M primary colors comprise a first primary color, a second primary color, . . . and an M-th primary color, a wavelength of the M-th primary color is less than at least some wavelengths of the first primary color to an (M−1)-th primary color, each of the E sub-regions is delimited by at least three primary color points and at most (M−1) primary color points, and at least one of the E sub-regions is delimited by a plurality of primary color points excluding an M-th primary color point corresponding to the M-th primary color.

8. The image conversion method according to claim 7, wherein the M primary color points of the chromatic diagram at least comprise a red (R) primary color point, a green (G) primary color point and a blue (B) primary color point; and
at least one of the M primary color points of the chromatic diagram is located outside an RGB region delimited by the R primary color point, the G primary color point and the B primary color point in the chromatic diagram; or
the R primary color point, the G primary color point and the B primary color point correspond to an R primary color, a G primary color and a B primary color, respectively, and wavelengths of the R primary color, the G primary color and the B primary color decrease in sequence;
in addition to the R primary color point, the G primary color point and the B primary color point, the M primary color points of the chromatic diagram further comprise at least one newly added primary color point; and
a wavelength of a newly added primary color corresponding to the at least one newly added primary color point is located between the wavelength of the G primary color and the wavelength of the B primary color.

9. The image conversion method according to claim 7, wherein a sub-region is delimited by three primary color points;
determining primary colors required to form the target color corresponding to the target color point according to the positional relationship between the target color point and each of the E sub-regions, denoting each of the primary colors as the first-type primary color, and denoting each of the other primary colors as the second-type primary color comprise:
determining three primary colors required to form the target color corresponding to the target color point according to the positional relationship between the target color point and each of the E sub-regions, denoting each of the three primary colors as the first-type primary color, and denoting each of the other primary colors as the second-type primary color.

10. The image conversion method according to claim 7, wherein M=4, and E=2;
the chromatic diagram comprises a red (R) primary color point, a green (G) primary color point, a cyan (C) primary color point and a blue (B) primary color point, and wavelengths of an R primary color, a G primary color, a C primary color and a B primary color corresponding to the R primary color point, the G primary color point, the C primary color point and the B primary color point decrease in sequence; and
the E sub-regions of the chromatic diagram comprise an RGC region delimited by the R primary color point, the G primary color point and the C primary color point and an RCB region delimited by the R primary color point, the C primary color point and the B primary color point.

11. The image conversion method according to claim 9, wherein M≥5;
the number of sub-regions delimited by the three primary color points excluding the M-th primary color point is P, and 1≤P<E; and
$$0.5 \leq P / E < 1 .$$

12. The image conversion method according to claim 7, wherein
an area of a largest region enclosed by all the M primary color points is S;
a sum of areas of sub-regions delimited by a plurality of primary color points excluding the M-th primary color point is S′; and
$$0.5 \leq {S}^{′} / S < 1 .$$

13. The image conversion method according to claim 7, wherein
a wavelength of the first primary color is greater than at least some wavelengths of the second primary color to the M-th primary color; and
at least one of the E sub-regions is delimited by a plurality of primary color points excluding a first primary color point corresponding to the first primary color.

14. The image conversion method according to claim 13, wherein
a first sub-region is a sub-region delimited by the plurality of primary color points excluding the first primary color point, and the plurality of primary color points delimiting the first sub-region do not comprise the M-th primary color point; and/or
a second sub-region is a sub-region delimited by a plurality of primary color points excluding the M-th primary color point, and the plurality of primary color points delimiting the second sub-region comprise the first primary color point.

15. The image conversion method according to claim 14, wherein M=5, and E=3;
the chromatic diagram comprises a red (R) primary color point, a yellow (Y) primary color point, a green (G) primary color point, a cyan (C) primary color point and a blue (B) primary color point, and wavelengths of an R primary color, a Y primary color, a G primary color, a C primary color and a B primary color corresponding to the R primary color point, the Y primary color point, the G primary color point, the C primary color point and the B primary color point decrease in sequence; and
the E sub-regions of the chromatic diagram comprise a YGC region delimited by the Y primary color point, the G primary color point and the C primary color point, an RYC region delimited by the R primary color point, the Y primary color point and the C primary color point and an RCB region delimited by the R primary color point, the C primary color point and the B primary color point.

16. The image conversion method according to claim 13, wherein M≥5, and E≥4;
the number of sub-regions delimited by three primary color points excluding the first primary color point is Q, and 1≤Q<E; and
$$0.5 \leq Q / E < 1 .$$

17. The image conversion method according to claim 11, wherein M=5, and E=4;
the chromatic diagram comprises a red (R) primary color point, a green (G) primary color point, a cyan (C) primary color point, a blue (B) primary color point and a white (W) primary color point, wavelengths of an R primary color, a G primary color, a C primary color and a B primary color corresponding to the R primary color point, the G primary color point, the C primary color point and the B primary color point decrease in sequence, and a wavelength of a W primary color corresponding to the W primary color point overlaps wavelengths of a plurality of primary colors; and
the E sub-regions of the chromatic diagram comprise an RGW region delimited by the R primary color point, the G primary color point and the W primary color point, a GCW region delimited by the G primary color point, the C primary color point and the W primary color point, a CBW region delimited by the C primary color point, the B primary color point and the W primary color point and an RBW region delimited by the R primary color point, the B primary color point and the W primary color point.

18. The image conversion method according to claim 11, wherein M=6, and E=5;
the chromatic diagram comprises a red (R) primary color point, a yellow (Y) primary color point, a green (G) primary color point, a cyan (C) primary color point, a blue (B) primary color point and a white (W) primary color point, wavelengths of an R primary color, a Y primary color, a G primary color, a C primary color and a B primary color corresponding to the R primary color point, the Y primary color point, the G primary color point, the C primary color point and the B primary color point decrease in sequence, and a wavelength of a W primary color corresponding to the W primary color point overlaps wavelengths of a plurality of primary colors; and
the E sub-regions of the chromatic diagram comprise a YGC region delimited by the Y primary color point, the G primary color point and the C primary color point, an RYW region delimited by the R primary color point, the Y primary color point and the W primary color point, a YCW region delimited by the Y primary color point, the C primary color point and the W primary color point, a CBW region delimited by the C primary color point, the B primary color point and the W primary color point and an RBW region delimited by the R primary color point, the B primary color point and the W primary color point.

19. The image conversion method according to claim 13, wherein
an area of a largest region enclosed by all the M primary color points is S;
a sum of areas of the sub-regions delimited by the plurality of primary color points excluding the first primary color point is S″; and
$$0.5 \leq {S}^{″} / S < 1 .$$

20. A display device, comprising a plurality of pixel units, wherein each of the plurality of pixel units comprises M types of primary color pixels, Mis an integer, and M≥4;
a display mode of the display device comprises a first display mode;
in the first display mode and a same pixel unit, N types of primary color pixels are in a bright state, (M−N) types of primary color pixels are in a black state, N is an integer, and 3≤N<M; and
in the first display mode, at least some light wavelengths of the (M−N) types of primary color pixels in the black state are at least less than at least some light wavelengths of (N−1) types of primary color pixels in the bright state.
